(19) United States
(12) Patent Application Publication
(10) Pub. No.: US 2011/0216106 A1
(43) Pub. Date: Sep. 8, 2011

(54) DISPLAY DEVICE AND ELECTRIC APPARATUS USING THE SAME

(75) Inventors: Akio Miyata, Nara (JP); Shinichi Nakano, Nara (JP); Syuichi Kouzaki, Nara (JP)

(73) Assignee: Sharp Kabushiki Kaisha, Osaka (JP)

(21) Appl. No.: 13/109,214

(22) Filed: May 17, 2011

Related U.S. Application Data
(62) Division of application No. 11/633,595, filed on Dec. 5, 2006.

(51) Int. Cl. G09G 5/10

(52) U.S. Cl. 345/690

(57) ABSTRACT

In a display device including: a display space provided on a display surface side; and a conductive liquid sealed inside the display space so as to be operable, which is constituted so as to be able to change a display color on the display surface side according to an application of an electric field to the conductive liquid, a power source portion, a first driving circuit that is connected to the power source portion, and allows the conductive liquid to flow into an inside of the display space according to a voltage applied by the power source portion, and a second driving circuit that is connected to the power source portion, and allows the conductive liquid to flow out of the inside of the display space according to a voltage applied by the power source portion are provided.

### CROSS-REFERENCE TO RELATED APPLICATION

This application is a divisional of U.S. application Ser. No. 11/633,595, filed Dec. 5, 2006, which is incorporated herein in its entirety.

### BACKGROUND OF THE INVENTION

1. Field of the Invention

The present invention relates to a display device that utilizes an electrowetting phenomenon to move a liquid, thereby displaying information such as images and characters, and an electric apparatus using the same.

2. Description of Related Art

Conventionally, display devices that display information by utilizing a moving phenomenon of a transparent or colored liquid have been suggested. For example, display devices that utilize an external electric field to move a liquid, thereby displaying information, include those of an electroosmosis system and of an electrowetting system.

In the display devices of the electroosmosis system, a liquid impregnation rate of a surface of a porous body is controlled so as to scatter external light, whereby a light reflectance and a light transmittance thereof with respect to the external light are controlled. Also, these display devices of the electroosmosis system have a configuration in which the porous body and the transparent liquid that have an equal refractive index are prepared in advance so as to achieve transparency by filling the liquid in through holes (small holes) in the porous body and cause light to be scattered by allowing the liquid to flow out from the through holes.

In the display devices of the electrowetting system, an electric field is applied to a liquid inside small pores so as to vary an interfacial tension of the liquid, thus causing this liquid to move by an electrocapillary phenomenon (an electrowetting phenomenon). More specifically, when a switch between a pair of electrodes provided on an inner surface of a small hole is closed so as to apply an electric field to the liquid, a wettability of the liquid with respect to the inner surface of the small hole varies. Accordingly, a contact angle of the liquid with respect to the inner surface of the small hole decreases, so that the liquid moves inside the small hole. On the other hand, when the switch is opened to stop the application of electric field to the liquid, the wettability of the liquid with respect to the inner surface of the small hole varies, thus increasing the contact angle sharply, so that the liquid flows out from the small hole.

In order to display moving images in the display devices described above, the liquid has to be moved inside the small hole at a high speed and at a low voltage. When the electroosmosis system and the electrowetting system are compared in this respect, the electrowetting system is more suitable for displaying moving images because it can move the liquid at a higher speed.

Further, using the conventional display devices, image displays utilizing the electrowetting phenomenon are provided as described in JP 10 (1998)-39799 A, for example.

More specifically, as shown in FIG. 15, a display device according to the above-noted conventional example is constituted by transparent sheets, and includes a first sheet 1, a second sheet 2 and a third sheet 3 that are arranged in this order from an upper side of FIG. 15 (a display surface side) with predetermined gaps therebetween. An upper side passage 4 is provided between the first sheet 1 and the second sheet 2, and a lower side passage 5 is provided between the second sheet 2 and the third sheet 3. Also, the second sheet 2 is provided with reservoirs 6 and 7 that allow the upper side passage 4 and the lower side passage 5 to communicate with each other. Furthermore, inside the upper side passage 4, the lower side passage 5, the reservoirs 6 and 7, a conductive liquid L1 that is colored in a predetermined color and has a conductivity and a transparent liquid L2 that is transparent are sealed.

Moreover, in this display device according to this conventional example, first electrodes 8A and 8B respectively are disposed on a lower surface side of the first sheet 1 and an upper surface side of the second sheet 2 so as to sandwich the upper side passage 4. Also, inside the upper side passage 4, a second electrode 9 is disposed at a position opposed to an upper end opening of the reservoir 6. The first electrodes 8A, 8B and the second electrode 9 are connected to a direct current power supply as shown in FIG. 15, thereby making it possible to apply an electric field to the conductive liquid L1.

In the display device according to the conventional example having the above-described configuration, a circuit between the first electrodes 8A, 8B and the second electrode 9 is closed to apply a voltage between these electrodes, thereby both moving the transparent liquid L2 inside the upper side passage 4 to a side of the lower side passage 5 and moving the conductive liquid L1 from a side of the reservoir 6 to a side of the upper side passage 4 so as to cause the above-mentioned predetermined color to be present on the display surface side.

On the other hand, the above-described circuit is opened, thereby both returning the conductive liquid L1 from the side of the upper side passage 4 to the side of the reservoir 6 and moving the transparent liquid L2 from the side of the reservoir 7 to the side of the upper side passage 4, so that the transparent display is achieved on the display surface side.

However, the above-described conventional display device has a problem in that the moving speed of the conductive liquid L1 toward the side of the reservoir 6 sometimes becomes significantly lower than the moving speed of the conductive liquid L1 toward the side of the upper side passage 4, which makes difficult to display moving images suitably. More specifically, in the conventional display device, by applying a voltage between the first electrodes 8A, 8B and the second electrode 9, the conductive liquid L1 is moved toward the side of the upper side passage 4, thereby carrying out a colored display by the conductive liquid L1. Thus, when the colored display is stopped by returning the conductive liquid L1 from the side of the upper side passage 4 to the side of the reservoir 6, the above-described application of the voltage is stopped so as to increase a contact angle of the conductive liquid L1 with respect to surfaces of the first sheet 1 and the second sheet 2 that surround the upper side passage 4, thereby returning the conductive liquid L1 toward the side of the reservoir 6. That is, the moving speed of the conductive liquid L1 toward the side of the reservoir 6 depends on physical properties of the constituents such as a composition of the conductive liquid L1 and materials of the first sheet 1 and the second sheet 2, and thus the increase of the moving speed is limited. As a result, the conventional display device has a problem in that it is difficult to display moving images suitably.

### SUMMARY OF THE INVENTION

Therefore, with the foregoing in mind, it is an object of the present invention to provide a display device that can move a conductive liquid at a high speed and display moving images suitably and easily, and an electric apparatus using the same.

In order to attain the above-mentioned object, the above-described display device of the present invention is a display device including: a display space provided on a display surface side; and a conductive liquid sealed inside the display space so as to be operable, the display device being constituted so as to be able to change a display color on the display surface side according to an application of an electric field to the conductive liquid, wherein a power source portion, a first driving circuit that is connected to the power source portion, and allows the conductive liquid to flow into an inside of the display space according to a voltage applied by the power source portion, and a second driving circuit that is connected to the power source portion, and allows the conductive liquid to flow out of the inside of the display space according to a voltage applied by the power source portion are provided.

In the display device with the above-described configuration, the first driving circuit allows the conductive liquid to flow into the inside of the display space according to the voltage applied by the power source portion, and the second driving circuit allows the conductive liquid to flow out of the inside of the display space according to the voltage applied by the power source portion are provided. Thus, unlike the above-described conventional example, the moving speed of the conductive liquid can be raised, regardless of the physical properties of the constituents including the compositions of the conductive liquid and the like. As a result, the conductive liquid can be moved at a high speed, thus making it possible to display moving images suitably and easily.

Moreover, the above-described display device preferably include: a transparent upper layer provided on the display surface side; and a back surface layer provided on a non-display surface side of the upper layer, wherein the display space is formed between the upper layer and the back surface layer, a communication space whose one end side is in communication with the display space is provided in the back surface layer so that the conductive liquid can flow, the first driving circuit is provided with a transparent upper electrode provided on the upper layer side and an upper switch connected between the upper electrode and the power source portion, and allows the conductive liquid to flow from the communication space side to the display space side when the upper switch becomes in an ON, and the second driving circuit is provided with a lower electrode provided on the back surface layer side and a lower switch connected between the lower electrode and the power source portion, and allows the conductive liquid to flow out from the display space side to the communication space side when the lower switch becomes in an ON.

In this case, since the conductive liquid can be moved toward the display space side or the communication space side according to operations of opening/closing the upper switch and the lower switch, it is possible to improve the moving speed of the conductive liquid and change the display color on the display surface side with high precision.

Moreover, in the display device, it is preferable that a dielectric layer is layered on a surface of the upper electrode and a surface of the lower electrode.

In this case, the electric field to be applied by the dielectric layer to the conductive liquid is increased reliably, thereby improving the moving speed of this liquid more easily.

Moreover, in the above-described display device, one power source that is to be connected to the first driving circuit or the second driving circuit may also be used in the power source portion.

In this case, an increase of a size of the circuit of the display device can be prevented, and the display device with a simple configuration, which can carry out a suitable display of moving images easily, can be structured.

Moreover, in the above-described display device, a first power source and a second power source that are respectively connected to the first driving circuit and the second driving circuit may also be used in the power source portion.

In this case, the first driving circuit and the second driving circuit can move the conductive liquid independently of each other, and it is possible to raise the moving speed of the conductive liquid more easily. Moreover, the first driving circuit and the second driving circuit can easily carry out a control of the movement of the conductive liquid according to a voltage difference between a voltage applied by the first power supply and a voltage applied by the second power supply, besides an ON/OFF control that is carried out by each of the upper switch and the lower switch.

Moreover, in the above-described display device, it is also possible that the conductive liquid is colored in a predetermined color, a light-reflecting layer is used in the back surface layer, and a display color on the display surface side becomes the predetermined color when the first driving circuit allows the conductive liquid to flow from the communication space side to the display space side, and becomes white resulting from the light-reflecting layer when the second driving circuit allows the conductive liquid to flow out from the display space side to the communication space side.

In this case, the display device that can change the display color on the display surface side between the predetermined color and white can be structured. Moreover, since the white display is achieved resulting from the light-reflecting layer, display quality of the white display can be improved easily.

Moreover, in the above-described display device, it is also possible that the back surface layer includes: an intermediate layer provided on the non-display surface side of the upper layer so that an upper space constituting the display space is formed between the upper layer and the intermediate layer; and the lower layer provided on a non-display surface side of the intermediate layer, a lower space included in the communication space is formed between the intermediate layer and the lower layer, a through hole, which is included in the communication space and whose one end side and other end side are respectively in communication with the upper space and the lower space, is formed in the intermediate layer, and a common electrode provided in the intermediate layer is connected to the first driving circuit and the second driving circuit so as to be able to contact with the conductive liquid and surround the through hole.

In this case, since the display color on the display surface side is changed when the conductive liquid is moved toward the upper space side or the lower space side, the display color can be changed with higher precision. Furthermore, since the common electrode is used, an increase of the number of the components in the display device can be prevented, the display device with a simple structure can be obtained easily.

Moreover, in the above-described display device, it is preferable that a conductor that is layered on the intermediate layer is used for the common electrode.

In this case, the common electrode can be provided easily, and the display device can be structured in simplified manufacturing processes.

Moreover, in the above-described display device, it is preferable that a plurality of the through holes, each of which has a communication point with the upper space and a communication point with the lower space that are different from each other, are formed in the intermediate layer.

In this case, since the conductive liquid can be circulated inside the upper space and the lower space when the conductive liquid is moved, a speed of changing the display color on the display surface side can be increased easily.

Moreover, in the above-described display device, it is also possible that the back surface layer includes: an intermediate layer provided on the non-display surface side of the upper layer so that an upper space constituting the display space is formed between the upper layer and the intermediate layer; and the lower layer provided on a non-display surface side of the intermediate layer, a through hole, which is included in the communication space and whose one end side is in communication with the upper space, is formed in the intermediate layer, the lower layer is provided on the intermediate layer so as to close the other end side of the through hole, and a common electrode provided in the intermediate layer is connected to the first driving circuit and the second driving circuit so as to be able to contact with the conductive liquid.

In this case, the compact display device with the simple configuration can be structured more easily.

Moreover, in the above-described display device, it is preferable that a conductor that is layered on the intermediate layer is used for the common electrode.

In this case, the common electrode can be provided easily, and the display device can be structured in simplified manufacturing processes.

Moreover, in the above-described display device, the one end side of the communication space may also be in communication with a central portion of the display space.

In this case, the movement of the conductive liquid from the communication space to a peripheral portion side of the display space, and the movement of the conductive liquid from the peripheral portion of the display space to the communication space side can be achieved at a uniform speed.

Moreover, in the above-described display device, the one end side of the communication space may also be in communication with an one end portion of the display space.

In this case, the conductive liquid can be moved smoothly toward the display space side or the communication space side.

Moreover, in the above-described display device, it is also possible that the conductive liquid is colored in a predetermined color, a light-transmitting layer is used in the back surface layer, a back light is provided on a non-display surface side of the back surface layer, and a display color on the display surface side becomes the predetermined color when the first driving circuit allows the conductive liquid to flow from the communication space side to the display space side, and becomes white resulting from the back light when the second driving circuit allows the conductive liquid to flow out from the display space side to the communication space side.

In this case, since the white display is achieved resulting from the back light, the display quality of the white display can be improved easily. Moreover, because of using the back light, the operation of display can be carried out reliably, even when external light is not sufficient.

Moreover, in the above-described display device, it is also possible that the conductive liquid is colored in a predetermined color, a light-reflecting layer and a light-transmitting layer disposed in parallel are used in the back surface layer, a back light is provided on a non-display surface side of the back surface layer, and a display color on the display surface side becomes the predetermined color when the first driving circuit allows the conductive liquid to flow from the communication space side to the display space side, and becomes white resulting from the light-reflecting layer and the back light when the second driving circuit allows the conductive liquid to flow out from the display space side to the communication space side.

In this case, since the white display is achieved by the light-reflecting layer and the back light, the display quality of the white display can be improved easily. Furthermore, because of using the external light besides the back light, power consumption of the back light can be decreased.

Moreover, in the above-described display device, it is also possible that a light-scattering particle is mixed into the conductive liquid, a surface of the back surface layer on a non-display surface side is colored in a predetermined color, and a display color on the display surface side becomes white when the first driving circuit allows the conductive liquid to flow from the communication space side to the display space side, and becomes the predetermined color resulting from the surface of the back surface layer on the non-display surface side when the second driving circuit allows the conductive liquid to flow out from the display space side to the communication space side.

In this case, since the white display is achieved resulting from the above-described light-scattering particles, the display quality of the white display can be improved easily.

Moreover, in the above-described display device, it is preferable that an insulating fluid that is not mixed with the conductive liquid is sealed inside the display space.

In this case, it is possible to raise the moving speed of the above-noted conductive liquid easily. Also, as the insulating fluid, it is preferable to use a fluid that is transparent or colored in a color different from the above-mentioned predetermined color, for example, a nonpolar oil containing one or plural kinds selected from the group consisting of side-chain higher alcohol, side-chain higher fatty acid, alkane, a silicone oil and a matching oil. In other words, when using a nonpolar oil that is not compatible with the above-noted conductive liquid, it becomes possible to move the conductive liquid at a higher speed compared with the case of using other insulating fluid such as the air. This makes it easier to raise the speed of changing the display color on the display surface side.

Moreover, in the above-described display device, it is preferable that a plurality of the display spaces are respectively provided according to a plurality of colors, by which a full-color display can be carried out on the display surface side.

In this case, by moving the corresponding conductive liquids in the plurality of the display spaces in a suitable manner, it is possible to display a color image.

Moreover, the electric apparatus of the present invention is an electric apparatus including a display portion for displaying information including a character and an image, wherein a display device, which is provided with: a display space provided on a display surface side; and a conductive liquid sealed inside the display space so as to be operable, and is constituted so as to be able to change a display color on the display surface side according to an application of an electric field to the conductive liquid, is used as the display portion, and a power source portion; a first driving circuit that is connected to the power source portion, and allows the conductive liquid to flow into an inside of the display space according to a voltage applied by the power source portion; and a second driving circuit that is connected to the power source portion, and allows the conductive liquid to flow out of the inside of the display space according to a voltage applied by the power source portion are provided.

In the electric apparatus with the above-described configuration, the display device that can move the conductive liquid at a high speed and can display moving images suitably and easily is used as the display portion, and thus it is possible to easily structure the electric apparatus that has an excellent displaying property and is provided with the display portion suitable for displaying moving images.

These and other advantages of the present invention will become apparent to those skilled in the art upon reading and understanding the following detailed description with reference to the accompanying figures.

### BRIEF DESCRIPTION OF THE DRAWINGS

FIG. 1 is a sectional view showing a configuration of a main portion of a display device and an image display according to Embodiment 1 of the present invention in a state of displaying a color resulting from a conductive liquid.

FIG. 2 is a sectional view showing the configuration of the main portion of the display device and the image display described above in a state of displaying white.

FIG. 3A is a sectional view showing a configuration of a main portion of a modified embodiment of the display device and the image display shown in FIG. 1 in the state of displaying a color resulting from the conductive liquid.

FIG. 3B is a sectional view showing the configuration of the main portion of the display device and the image display shown in FIG. 3A in the state of displaying white.

FIG. 4A is a sectional view showing a configuration of a main portion of a display device and an image display according to Embodiment 2 of the present invention in a state of displaying a color resulting from a liquid.

FIG. 4B is a sectional view showing the configuration of the main portion of the display device and the image display shown in FIG. 4A in a state of displaying white.

FIG. 5 is a sectional view showing a configuration of a main portion of a modified embodiment of the display device and the image display shown in FIG. 4A in the state of displaying a color resulting from the conductive liquid.

FIG. 6A is a sectional view showing a configuration of a main portion of a display device and an image display according to Embodiment 3 of the present invention in a state of displaying a color resulting from a conductive liquid.

FIG. 6B is a sectional view showing the configuration of the main portion of the display device and the image display shown in FIG. 6A in a state of displaying white.

FIG. 7A is a sectional view showing a configuration of a main portion of a display device and an image display according to Embodiment 4 of the present invention in a state of displaying a color resulting from a conductive liquid.

FIG. 7B is a sectional view showing the configuration of the main portion of the display device and the image display shown in FIG. 7A in a state of displaying white.

FIG. 8A is a sectional view showing a configuration of a main portion of a display device and an image display according to Embodiment 5 of the present invention in a state of displaying a color resulting from a conductive liquid.

FIG. 8B is a sectional view showing the configuration of the main portion of the display device and the image display shown in FIG. 8A in a state of displaying white.

FIG. 9A is a sectional view showing a configuration of a main portion of a display device and an image display according to Embodiment 6 of the present invention in a state of displaying a color resulting from a conductive liquid.

FIG. 9B is a sectional view showing the configuration of the main portion of the display device and the image display shown in FIG. 9A in a state of displaying white.

FIG. 10A is a sectional view showing a configuration of a main portion of a display device and an image display according to Embodiment 7 of the present invention in a state of displaying a color resulting from a conductive liquid.

FIG. 10B is a sectional view showing the configuration of the main portion of the display device and the image display shown in FIG. 10A in a state of displaying white.

FIG. 11A is a sectional view showing a configuration of a main portion of a display device and an image display according to Embodiment 8 of the present invention in a state of displaying a color resulting from a conductive liquid.

FIG. 11B is a sectional view showing the configuration of the main portion of the display device and the image display shown in FIG. 11A in a state of displaying white.

FIG. 12 is a sectional view showing a configuration of a main portion of a display device and an image display according to Embodiment 9 of the present invention in a state of displaying a color resulting from a conductive liquid.

FIG. 13 is a sectional view showing a configuration of a main portion of a display device and an image display according to Embodiment 10 of the present invention in a state of displaying a color resulting from a conductive liquid.

FIG. 14A is a sectional view showing a configuration of a main portion of a display device and an image display according to Embodiment 11 of the present invention in a state of displaying a color resulting from a conductive liquid.

FIG. 14B is a sectional view showing the configuration of the main portion of the display device and the image display shown in FIG. 14A in a state of displaying white.

FIG. 15 is a sectional view showing a configuration of a main portion of a conventional display device and a conventional image display.

### DETAILED DESCRIPTION OF THE INVENTION

The following is a description of preferred embodiments of a display device and an electric apparatus according to the present invention, with reference to the accompanying drawings. In the description below, a case of applying the present invention to an image display including a display portion capable of displaying a color image will be illustrated.

### Embodiment 1

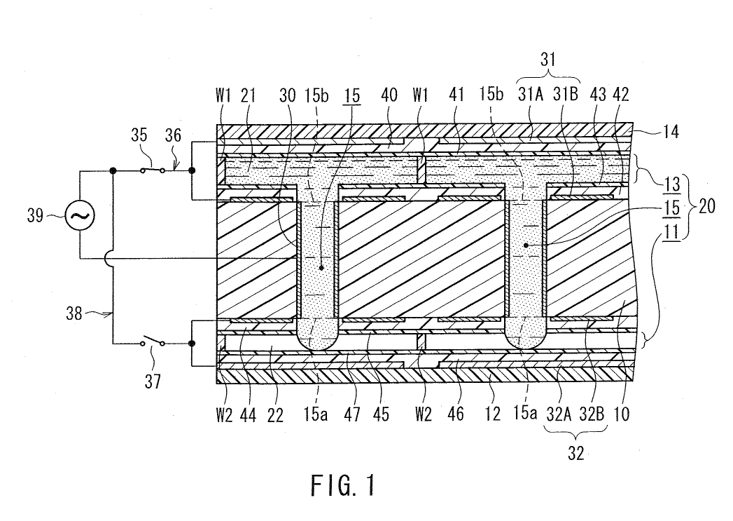

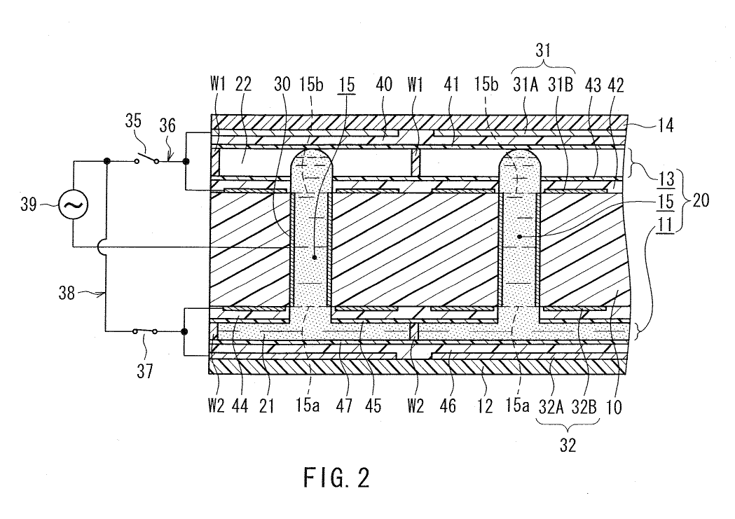

FIG. 1 is a sectional view showing a configuration of a main portion of a display device and an image display according to Embodiment 1 of the present invention in a state of displaying a color resulting from a conductive liquid. FIG. 2 is a sectional view showing the configuration of the main portion of the display device and the image display described above in a state of displaying white.

In FIGS. 1 and 2, the image display according to the present embodiment is provided with a display portion constituted by the display device according to the present invention. In this display portion, an upper side in the figure corresponds to a display surface side recognized visually by a user. The above-noted display device includes a reflecting sheet 10 for scattering external light from the display surface side so as to display white, a lower electrode substrate 12 provided on a non-display surface side of the reflecting sheet 10 such that a rectangular lower space 11 is formed between the reflecting sheet 10 and the lower electrode substrate 12, and an upper electrode substrate 14 provided on the display surface side of the reflecting sheet 10 such that a rectangular upper space 13 is formed between the reflecting sheet 10 and the upper electrode substrate 14. The upper electrode substrate 14 is formed of a transparent insulating material, and constitutes a transparent upper layer that is provided on the display surface side. Moreover, the reflecting sheet 10 and the lower electrode substrate 12 are formed of an insulating material and respectively constitute an intermediate layer and a lower layer. Furthermore, the reflecting sheet 10 and the lower electrode substrate 12 constitute a back surface layer that is provided on the non-display surface side of the upper layer.

Further, in the display device, the upper space 13 and the lower space 11 respectively are partitioned off by a plurality of partition walls W1 and W2, so that a plurality of pixel regions are formed in a transverse direction of the figure and a direction perpendicular to the paper surface of the figure. Moreover, in the display device, the pixel regions for individual colors of R, G and B are provided so as to be adjacent to one another as a single picture element, for example, thus allowing a full-color display on the above-noted display surface side.

In a central portion of each of the pixel regions of the reflecting sheet 10, a through hole 15 penetrating through the reflecting sheet 10 in its thickness direction (the vertical direction in the figures) is provided. This through hole 15 constitutes a communication space with the lower space 11, and one end thereof is in communication with the upper space 13 constituting a display space. Also, the other end of the through hole 15 is in communication with the lower space 11, and the upper space 13 and the lower space 11 are in communication with each other via the through hole 15. In other words, a lower end opening 15a of the through hole 15 is provided so as to be opposed to the lower electrode substrate 12, and an upper end opening 15b thereof is provided so as to be opposed to the upper electrode substrate 14, so that the through hole 15, the lower space 11 and the upper space 13 form a liquid storage portion 20 having an I-shaped cross-section in each of the pixels.

In the liquid storage portion 20, a conductive liquid 21 as the liquid colored in a predetermined color of R, G or B and a nonpolar oil 22 are sealed.

The nonpolar oil 22 has a physical property of not mixing with the conductive liquid 21. As the nonpolar oil 22, an oil that is transparent or colored in a color different from the conductive liquid 21 and contains one or plural kinds selected from the group consisting of side-chain higher alcohol, side-chain higher fatty acid, alkane, a silicone oil and a matching oil is used. In this way, by using the nonpolar oil 22 that is not compatible with the conductive liquid 21, a liquid drop of the conductive liquid 21 moves in the nonpolar oil 22 more easily, making it possible to move the conductive liquid 21 at a high speed.

Further, in the two adjacent liquid storage portions 20 partitioned off by the partition walls W1 and W2, the conductive liquids 21 that are colored in different colors are sealed. In other words, a coloring agent such as a pigment or a dye of R, G or B is added to the conductive liquid 21, so that a display color on the display surface side can be a color corresponding to R, G or B.

The conductive liquid 21 is an ambient temperature molten salt formed of a 1-1 salt obtained by combining one kind of monovalent cation and one kind of monovalent anion, and is an ionic conductive liquid containing no water.

Particularly, the cation may be selected from the group consisting of 1,3-dialkylimidazolium cation, N-alkylpyridinium cation, tetraalkylammonium cation and tetraalkylphosphonium cation.

Furthermore, in the display device described above, the anion may be selected from the group consisting of (AlCl₃)nCl⁻, (AlBr₃)nBr⁻, Cl⁻, Br⁻, I⁻, (HF)nF⁻, (HF)₂F₃⁻, BF₄⁻, AlF₄⁻, PF₆⁻, AsF₆⁻, SbF₆⁻, NbF₆⁻, TaF₆⁻, CH₃SO₃⁻, WF₇⁻, NO₃⁻, NO₂⁻, VOCl₄⁻, CF₃SO₃⁻, (CF₃SO₂)₂N⁻, (CF₃SO₂)₃C⁻, C₄H₉SO₃⁻, (CF₃CF₂SO₂)N⁻, CF₃CO₂⁻, CF₃CF₂CF₂CO⁻, CF₃CF₂CF₂SO₃⁻, (CN)₂N⁻ and CH₃CO₂⁻, where n is an integer.

Also, since the above-noted anion have very different fundamental physical properties depending on their kinds, it is preferable to combine the anion and the cation so as to achieve an ionic liquid having physical properties described below:

the ionic liquid has a melting point of −4° C. to −90° C., is liquid at room temperature, is nonvolatile and thus has a vapor pressure of 0, has a wide liquid temperature region and an excellent thermal stability;

has an ionic conductivity (s/cm) of equal to or greater than 0.1×10⁻³ at room temperature (25° C.); and

has a viscosity of equal to or smaller than 300 cp at room temperature (25° C.).

The ionic liquid having the above-mentioned physical properties can contain chemical species of 1-ethyl-3-methylimidazolium (EMI), 1-butyl-3-methylimidazolium (BMI) or 1,2-dimethyl-3-propylimidazolium (DMPI) noted above.

Also, in the display device, for the purpose of applying a voltage to or removing a voltage from the conductive liquid 21 so as to move the conductive liquid 21 and replace it with the nonpolar oil 22, the display device has in each pixel a three-terminal structure including a common electrode 30 provided so as to surround the through hole 15, a transparent upper electrode 31 provided on a side of the upper space 13 and a lower electrode 32 provided on a side of the lower space 11.

More specifically, the common electrode 30 is provided along an inner surface of the reflecting sheet 10 surrounding the through hole 15. This common electrode 30 is an electrode made of a metal such as aluminum or copper and formed by a vacuum evaporation method, a sputtering method, an ion plating method, a dip coating method or the like.

Also, on a lower surface of the upper electrode substrate 14, an upper-side upper electrode 31A is provided so as to cover the display surface side of the upper space 13. Further, on the side of the reflecting sheet 10, a lower-side upper electrode 31B is provided on a surface opposed to the upper space 13 except for an opening of the through hole 15. These upper electrodes 31A and 31B are transparent electrodes using an ITO film or the like and connected electrically with each other. Incidentally, it is appropriate that the upper electrode 31 may be provided on a surface side opposed to the upper space 13 in at least one of the upper electrode substrate 14 and the reflecting sheet 10.

Moreover, on an upper surface of the lower electrode substrate 12, a lower-side lower electrode 32A is provided so as to cover the non-display surface side of the lower space 11. Further, on the side of the reflecting sheet 10, an upper-side lower electrode 32B is provided on a surface opposed to the lower space 11 except for an opening of the through hole 15. These lower electrodes 32A and 32B are electrodes made of a metal such as aluminum or copper and formed by a vacuum evaporation method, a sputtering method, an ion plating method, a dip coating method or the like. Incidentally, it is appropriate that the lower electrode 32 be provided on a surface side opposed to the lower space 11 in at least one of the lower electrode substrate 12 and the reflecting sheet 10. Moreover, similarly to the upper electrode 31, the lower electrode 32 may be constituted by a transparent electrode using an ITO film or the like.

Further, the upper electrode 31 and the common electrode 30 are connected to an alternating-current power supply 39 included in the power supply portion via an upper switch 35. The upper electrode 31, the common electrode 30 and the upper switch 35 constitute a first driving circuit 36 that allows the conductive liquid 21 to flow into an inside of the upper space (the display space) 13 according to a voltage applied by the power supply portion. On the other hand, the lower electrode 32 and the common electrode 30 are connected to the alternating-current power supply 39 via a lower switch 37. The lower electrode 32, the common electrode 30 and the lower switch 37 constitute a second driving circuit 38 that allows the conductive liquid 21 to flow out of the inside of the upper space 13 according to a voltage applied by the power supply portion. Then, in the display device, the application of the electric field to the conductive liquid 21 is started/stopped according to operations of closing/opening the upper switch 35 and the lower switch 37. Also, the first driving circuit 36 and the second driving circuit 38 are structured to change a display color on the display surface side, by moving the conductive liquid 21 toward the upper space 13 side or the lower space 11 side according to the operations of closing/opening the upper switch 35 and the lower switch 37. Moreover, in the display device, the conductive liquid 21 is moved by the electrowetting phenomenon by using one alternating-current power supply 39. Thereby, an increase of a size of the circuit of the display device can be prevented, and the display device with a simple configuration, which can carry out a suitable display of moving images easily, can be structured. Moreover, since the common electrode 30 is used, it is possible both to prevent an increase of the number of components in the display device and to obtain a display device with a simple structure easily.

The surfaces of the upper electrodes 31A and 31B are provided with dielectric layers 40 and 42, respectively. Also, the surfaces of the dielectric layers 40 and 42 are provided with insulating water-repellent films 41 and 43, respectively, which are in contact with the conductive liquid 21 or the nonpolar oil 22.

Likewise, the surfaces of the lower electrodes 32A and 32B are provided with dielectric layers 46 and 44, respectively. Also, the surfaces of the dielectric layers 46 and 44 are provided with insulating water-repellent films 47 and 45, respectively, which are in contact with the conductive liquid 21 or the nonpolar oil 22.

The dielectric layers 40, 42, 44 and 46 are formed of a high dielectric film containing parylene or aluminum oxide, for example, and have a thickness of about 1 to 0.1 μm. Also, the water-repellent films 41, 43, 45 and 47 preferably become layers having an affinity for the conductive liquid 21 at the time of applying a voltage. More specifically, a fluorocarbon resin is preferable.

Alternatively to the above description, the surface of the common electrode 30 also can be provided with a coating that becomes lipophilic in an ON (closed) state of the upper switch 35 or the lower switch 37 and becomes lipophobic in an OFF (opened) state of the upper switch 35 or the lower switch 37, thereby improving a moving speed of the nonpolar oil 22 at the time of the operation of closing/opening the upper switch 35 or the lower switch 37, so that the moving speed of the conductive liquid 21 can be raised as well. However, as shown in FIGS. 1 and 2, it is more preferable that the conductive liquid 21 constantly is in contact with the common electrode 30 regardless of the closing/opening operation of the upper switch 35 and the lower switch 37 so as to apply the voltage to this conductive liquid 21 directly, because the moving speed of the conductive liquid 21 can be improved easily.

As the reflecting sheet 10, a scattering reflector containing a transparent polymeric resin and plural kinds of fine particles that are added into the polymeric resin and have different refractive indices is used, thereby constituting the light-reflecting layer. Moreover, when the conductive liquid 21 flows out of the inside of the upper space 13 and the transparent nonpolar oil 22 flows into the upper space 13, this reflecting sheet 10 can display the display surface as white as paper. More specifically, in the reflecting sheet 10, the above-noted polymeric resin can be a thermoplastic resin or a thermosetting resin, for example, an epoxy resin, an acrylic resin, a polyimide resin, a polyamide resin, polycarbonate, Teflon (registered trademark) or the like. Also, in the reflecting sheet 10, fine particles of titanium oxide or alumina having a large refractive index and hollow polymer fine particles having a small refractive index are contained as the above-noted plural kinds of fine particles. They cause diffusion on the surface of the reflecting sheet 10, making it possible to achieve a color as white as paper.

Alternatively to the above description, a light-scattering sheet using glass, ceramic or the like also can be used.

Further, the above-described through hole 15 has a diameter of about 0.1 μm to 100 μm, and can raise the intensity of the electric field generated in the through hole 15 in the ON state of the upper switch 35 or the lower switch 37. This makes it possible to increase the moving speed of the conductive liquid 21 moving from the inside of the through hole 15 toward the upper space 13 or the lower space 11 by the electrowetting phenomenon.

Moreover, the reflecting sheet 10 has a thickness of preferably about 10 μm to 300 μm, more preferably 10 μm to 100 μm and particularly preferably about 50 μm. By setting the thickness of the reflecting sheet 10 to be very small, which is equal to or smaller than 1 mm, as above, it becomes possible to achieve a so-called paper display easily.

When the reflecting sheet 10 is set to have a thickness of 10 μm to 300 μm, the length of the through hole 15 in the vertical direction in the figure also is 10 μm to 300 μm. Thus, the conductive liquid 21 can be flowed in and out of the through hole 15 having a diameter of 0.1 μm to 100 μm and a length of 10 μm to 300 μm at a high speed by the electrowetting phenomenon.

The through hole 15 can be formed by a suitable method such as a photolithography method, an anodic oxidation method, an etching method, a dyeing method or a printing method.

The upper electrode substrate 14 and the lower electrode substrate 12 are formed using a transparent resin sheet similar to the reflecting sheet 10 so as to have a thickness of 10 to 300 μm. Also, each of the upper space 13 and the lower space 11 has a gap of 5 to 50 μm in the vertical direction of the figure, and the gap is preferably 10 μm. It should be noted that this gap is the corresponding dimension between the water-repellent films 41 and 43 or between the water-repellent films 45 and 47.

Herein, specific processes of manufacturing the display device in the present embodiment will be described.

As the reflecting sheet 10, a white scattering sheet (with a thickness of 75 μm) manufactured by FUJICOPIAN CO., LTD. was used. This white scattering sheet was made of a material obtained by kneading a PET resin with fine particles of titanium oxide so that white was achieved by the fine particles of titanium oxide.

After SiO₂ films as buffer layers (surface reforming films) were deposited on the surfaces of the reflecting sheet 10 by the sputtering method, ITO films as transparent electrodes were deposited by the sputtering method, thus forming the upper electrode 31B on the lower side of the upper space 13 and the lower electrode 32B on the upper side of the lower space 11. The SiO₂ films had a thickness of 30 nm, and the ITO films had a thickness of 100 nm.

The reflecting sheet 10 was provided with the through holes 15 having a diameter of 30 μmφ and a depth of 75 μm by an excimer laser processing using a mask with a large number of apertures. Incidentally, it also was possible to form the through holes by a micro-drill processing instead of the excimer laser processing.

A parylene film was formed on the ITO film surfaces on both the upper and lower surfaces of the reflecting sheet 10 provided with the through holes 15 by a vapor deposition method, thus forming the dielectric layers 42 and 44 having a thickness of 1 μm. Furthermore, the water-repellent films 43 and 45 manufactured by Fluoro Technology were formed on the surfaces of the dielectric layers 42 and 44, respectively, by a dipping method. Thereafter, they were burned at 80° C. for 30 minutes. These water-repellent films 43 and 45 had a thickness of 20 nm.

In order to form the lower electrode 32B around the through holes 15 in the reflecting sheet 10, an oblique deposition method was employed. A metal electrode material made of aluminum, tantalum or the like was deposited by the oblique deposition method so as to have a predetermined thickness.

The upper electrode substrate 14 was formed of a transparent PET resin, and on its surface opposed to the upper space 13, the upper electrode 31A formed of an SiO₂ film and an ITO film, the dielectric layer 40 formed of a parylene film and the water-repellent film 41 were formed in this order similarly to the reflecting sheet 10. Likewise, the lower electrode substrate 12 was formed of a transparent PET resin, and the lower electrode 32A formed of an SiO₂ film and an ITO film, the dielectric layer 46 formed of a parylene film and the water-repellent film 47 were formed thereon in this order.

Next, in order to form the lower space 11 having a gap of 10 μm between the lower electrode substrate 12 and the reflecting sheet 10, a resin spacer 10 μm in width and 10 μm in height was formed. Subsequently, a white UV curable resin was expelled to a peripheral portion of each of the through holes 15 using an ink jet method and allowed to solidify, thereby forming white partition walls W2 so that the conductive liquids 21 colored in predetermined colors of any of R, G and B were not mixed with each other.

Then, an ionic liquid (manufactured by Koei Chemical Co., Ltd.; trade name: IL-A4), which was an ambient temperature molten salt made of aliphatic amine and was a nonaqueous solution, was filled as the conductive liquid 21 into the through holes 15 and the lower space 11. Thereafter, by adding a predetermined pigment to the conductive liquid 21, the conductive liquid 21 was colored in any of R, G and B.

Subsequently, in order to form the upper space 13 having a gap of 10 μm between the upper electrode substrate 14 and the reflecting sheet 10, a resin spacer 10 μm in width and 10 μm in height was formed. Then, a white UV curable resin was expelled to a peripheral portion of each of the through holes 15 using an ink jet method and allowed to solidify, thereby forming white partition walls W1. Thereafter, an oil (n-dodecane; manufactured by Kishida Chemical Co., Ltd.) as the nonpolar oil 22 was filled into the upper space 13, and the upper electrode substrate 14 was attached and fixed onto the partition walls W1.

Subsequently, the upper electrode 31 and the lower electrode 32 were connected to one end of the alternating-current power supply 39 via the upper switch 35 and the lower switch 37, respectively. Further, the common electrode 30 was connected to the other end of the alternating-current power supply 39, thus completing the display device. As the alternating-current power supply 39, a power supply capable of applying an alternating voltage of 40 V to 100 V at a frequency of 10 KHz was used.

Then, when the upper switch 35 was turned ON while the through holes 15 and the lower space 11 were filled with the conductive liquid 21 and the upper space 13 was filled with the nonpolar oil 22, the conductive liquid 21 was ejected from the through holes 15 to the inside of the upper space 13 and spread out inside the upper space 13. On the other hand, when the upper switch 35 was turned OFF and the lower switch 37 was turned ON, the conductive liquid 21 spread from the inside of the upper space 13 via the through holes 15 toward the inside of the lower space 11. It was possible to confirm the operation in which the conductive liquid 21 was replaced with the nonpolar oil 22.

The following is a specific description of the operation of the display device of the present embodiment constituted as above.

In the display device constituted as above, by a voltage control of turning ON or OFF the upper switch 35 and the lower switch 37 alternately, the conductive liquid 21 is moved to the upper space 13 and the lower space 11 alternately via the through hole 15 by the electrowetting phenomenon.

As shown in FIG. 1, when the upper switch 35 is in an ON state and the lower switch 37 is in an OFF state, the conductive liquid 21 is present inside the upper space 13. At this time, the display color on the display surface side is a predetermined color of the conductive liquid 21.

On the other hand, as shown in FIG. 2, when the upper switch 35 is in the OFF state and the lower switch 37 is in the ON state, the conductive liquid 21 in the upper space 13 moves to the through hole 15 or toward the inside of the lower space 11, thus exposing the light-scattering surface of the reflecting sheet 10. Consequently, the display color on the display surface side becomes white.

More specifically, when the upper switch 35 is in the ON state and the lower switch 37 is in the OFF state, the wettability of the conductive liquid 21 with respect to the surfaces of the water-repellent films 41 and 43 varies in the upper space 13 on the side of the upper electrode 31 supplied with a voltage. As a result, an interfacial tension and a contact angle between the conductive liquid 21 and the above-noted surfaces decrease. Accordingly, the conductive liquid 21 is drawn by an external tension, which has increased relatively, moved from the through hole 15 toward the upper space 13 and spreads out inside the upper space 13.

On the other hand, when the upper switch 35 is in the OFF state and the lower switch 37 is in the ON state, the electric field is removed from the upper electrode 31. As a result, the external tension with respect to the conductive liquid 21 returns to an intrinsic interfacial tension of the conductive liquid 21 itself, so that the conductive liquid 21 is drawn toward the through hole 15 and returns from the through hole 15 toward the lower space 11. Furthermore, since the lower electrode 32 is turned ON, the conductive liquid 21 is sucked from the upper space 13 via the through hole 15 toward the lower space 11, so that the conductive liquid 21 can be moved at a high speed.

As described above, the display device is constituted as a double electrode structure in which the response speed can be raised by controlling both of the inflow of the conductive liquid 21 to the upper space 13 and the outflow of the conductive liquid 21 from the upper space 13 by the voltage control of both of the upper electrode 31 and the lower electrode 32. That is, in the display device, the first driving circuit 36 and the second driving circuit 38 can raise the moving speed of the conductive liquid 21 with respect to the upper space 13, making it possible to raise the speed of changing the display color of each pixel.

At the time of moving the conductive liquid 21 between the upper space 13 and the lower space 11 by the voltage control of switching between applying and removing the voltage as described above, the nonpolar oil 22 is moved to a position replaced with the conductive liquid 21.

In other words, when the conductive liquid 21 in the upper space 13 moves toward the lower space 11, the nonpolar oil 22 in the lower space 11 goes up from the inside of the lower space 11 and flows to the side of the upper space 13. Conversely, when the conductive liquid 21 in the lower space 11 moves toward the upper space 13, the nonpolar oil 22 in the upper space 13 goes down from the upper space 13 and returns to the side of the lower space 11.

In this manner, by turning ON/OFF the upper switch 35 and the lower switch 37 alternately so as to allow the conductive liquid 21 to be present in the upper space 13 while the voltage is applied to the upper electrode 31, a colored display is carried out on the display surface side. On the other hand, when the conductive liquid 21 is moved from the upper space 13 via the through hole 15 to the lower space 11, the upper space 13 achieves a white display because the conductive liquid 21 is not present any more.

Also, in the display device, as described above, each pixel is partitioned off by the partition walls W1 and W2, so that the first driving circuit 36 and the second driving circuit 38 can move the conductive liquid 21 toward the upper space 13 or the lower space 11 in each pixel. Consequently, in the display device, individual colors of R, G and B are displayed by allowing the conductive liquid 21 colored in its corresponding color to flow into the side of the upper space 13. Further, by allowing all the conductive liquids 21 to flow into the corresponding upper spaces 13 in the adjacent pixels of R, G and B, all of the external light can be absorbed, thus achieving a black display on the display surface side.

As described above, in the present embodiment, the first driving circuit 36 allows the conductive liquid 21 to flow into the inside of the upper space (the display space) 13, according to the voltage applied by the alternating-current power supply (the power supply portion) 39. Moreover, the second driving circuit 38 allows the conductive liquid 21 to flow out of the inside of the upper space 13, according to the voltage applied by the alternating-current power supply 39. Thus, in the present embodiment, unlike the above-described conventional example, the moving speed of the conductive liquid 21 can be raised, regardless of the physical properties of the constituents including the compositions of the conductive liquid. As a result, in the present embodiment, the conductive liquid 21 can be moved at a high speed, thus making it possible to display moving images suitably and easily.

Moreover, in the present embodiment, since the through hole (the communication hole) 15 is in communication with the central portion of the upper space 13, the movement of the conductive liquid 21 from the through hole 15 toward a peripheral portion side of the upper space 13 and movement of the conductive liquid 21 from the peripheral portion of the upper space 13 toward the through hole 15 side can be carried out at a uniform speed. This also applies to embodiments described below.

Alternatively to the above description, the upper electrode 31A and the lower electrode 32A respectively may be buried into the upper electrode substrate 14 and the lower electrode substrate 12 that are formed of an insulating material. In that case, it becomes possible to omit the dielectric layer 40 on the upper electrode substrate 14 and the dielectric layer 46 on the lower electrode substrate 12. Further, alternatively to the above description, a space that has a rectangular cross-section and a rectangular-parallelepiped shape also may be used instead of the through hole 15.

### Modified Embodiment of Embodiment 1

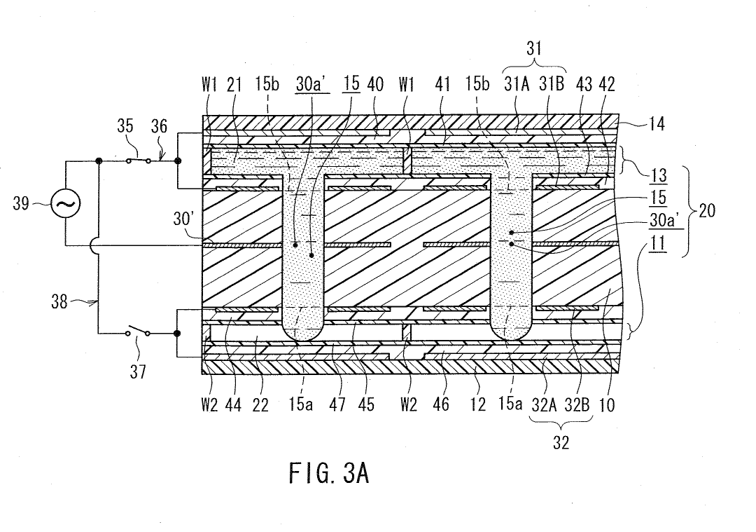

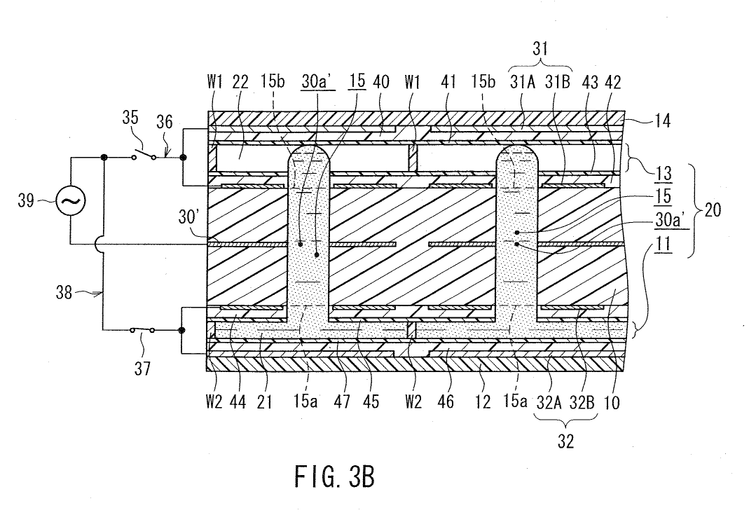

FIG. 3A is a sectional view showing a configuration of a main portion of a modified embodiment of the display device and the image display shown in FIG. 1 in the state of displaying a color resulting from the conductive liquid. FIG. 3B is a sectional view showing the configuration of the main portion of the display device and the image display shown in FIG. 3A in the state of displaying white. In these figures, a main difference between the present modified embodiment and the Embodiment 1 described above lies in the use of a conductive metal thin film for the common electrode. Incidentally, elements provided in common with the Embodiment 1 described above are given the same reference numerals, and the redundant description thereof will be omitted here.

That is, as shown in FIGS. 3A and 3B, in the present modified embodiment, a common electrode film 30′ as a conductor is used instead of the above-described common electrode 30. As this common electrode film 30′, a conductive metal thin film such as an aluminum film or a copper film is used, and the common electrode film 30′ is layered in an intermediate portion of the reflecting sheet 10 in the above-described thickness direction of the reflecting sheet 10 inside the reflecting sheet 10. Moreover, in the reflecting sheet 10 and the common electrode film 30′, the through hole 15 and a through hole 30a′ are respectively formed in each pixel, and the through hole 15 and the through hole 30a′ achieve communication between the upper space 13 and the lower space 11 so as to constitute a liquid storage portion 20.

With the configuration described above, the present modified embodiment can produce effects similar to those in the Embodiment 1 described above. Also, in the present modified embodiment, since a common electrode of the first driving circuit 36 and the second driving circuit 38 is constituted by one common electrode film (the conductor) 30′ unlike Embodiment 1, the common electrode can be provided more easily and the processes of manufacturing the display device can be simplified compared with Embodiment 1 in which the common electrode 30 is formed on the inner surface of the through hole 15.

### Embodiment 2

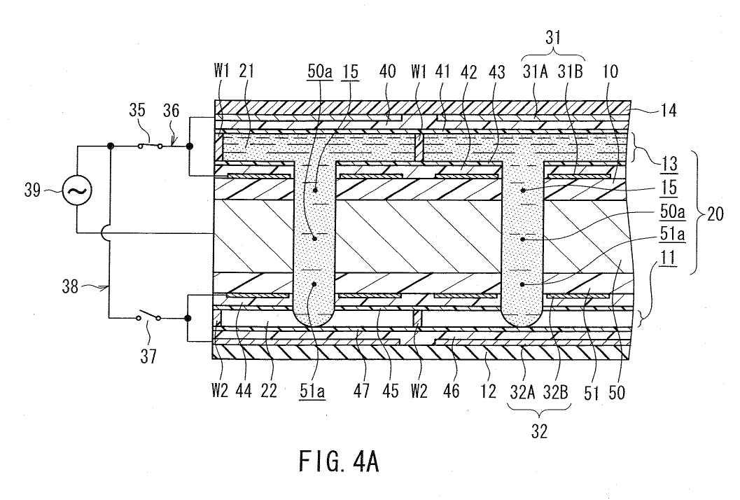

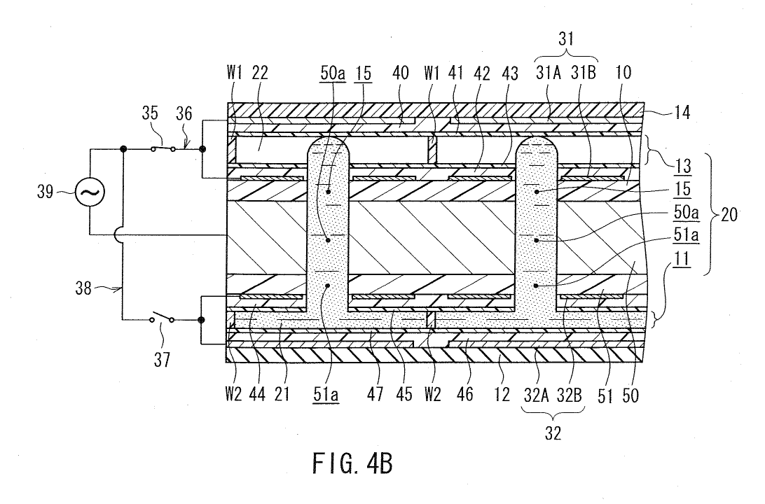

FIG. 4A is a sectional view showing a configuration of a main portion of a display device and an image display according to Embodiment 2 of the present invention in a state of displaying a color resulting from a conductive liquid. FIG. 4B is a sectional view showing the configuration of the main portion of the display device and the image display shown in FIG. 4A in a state of displaying white. In these figures, a main difference between the present embodiment and the Embodiment 1 described above lies in the use of a conductive metal sheet for the common electrode. Incidentally, elements provided in common with the Embodiment 1 described above are given the same reference numerals, and the redundant description thereof will be omitted here.

As shown in FIGS. 4A and 4B, in the present embodiment, a thinner reflecting sheet 10 is used, and a common electrode sheet 50 and an insulating sheet 51 are layered in this order on this reflecting sheet 10 on the side of the lower space 11. Also, the reflecting sheet 10, the common electrode sheet 50 and the insulating sheet 51 respectively are provided with the through hole 15, a through hole 50a and a through hole 51a in each pixel. When the reflecting sheet 10, the common electrode sheet 50 and the insulating sheet 51 are formed into one piece, the through hole 15, the through hole 50a and the through hole 51a achieve communication between the upper space 13 and the lower space 11 so as to constitute a liquid storage portion 20.

The common electrode sheet 50 constitutes the above-described common electrode 30 and is connected to the alternating-current power supply 39. Also, as this common electrode sheet 50, a conductive metal thin film such as an aluminum foil or a copper foil is used. Further, as the insulating sheet 51, a sheet of a synthetic resin, for example, a PET resin or the like is used. The lower electrode 32B, the dielectric layer 44 and the water-repellent film 45 are layered in this order on the surface of the insulating sheet 51 on the side of the lower space 11.

With the configuration described above, the present embodiment can produce effects similar to those in the Embodiment 1 described above. Also, in the present embodiment, since the first driving circuit 36 and the second driving circuit 38 are constituted by simply layering one common electrode sheet (the conductor) 50 on the reflecting sheet 10 unlike Embodiment 1, the common electrode can be provided more easily and the processes of manufacturing the display device can be simplified, compared with Embodiment 1 in which the common electrode 30 is formed on the inner surface of the through hole 15. Further, since a dimension of the common electrode sheet 50 of the present embodiment in the above-described thickness direction is larger than that of the common electrode film 30′ of the modified embodiment described above, an area that is contact with the conductive liquid 21 can be increased, and the moving speed of the conductive liquid 21 can be raised more easily than that of the modified embodiment described above.

### Modified Embodiment of Embodiment 2

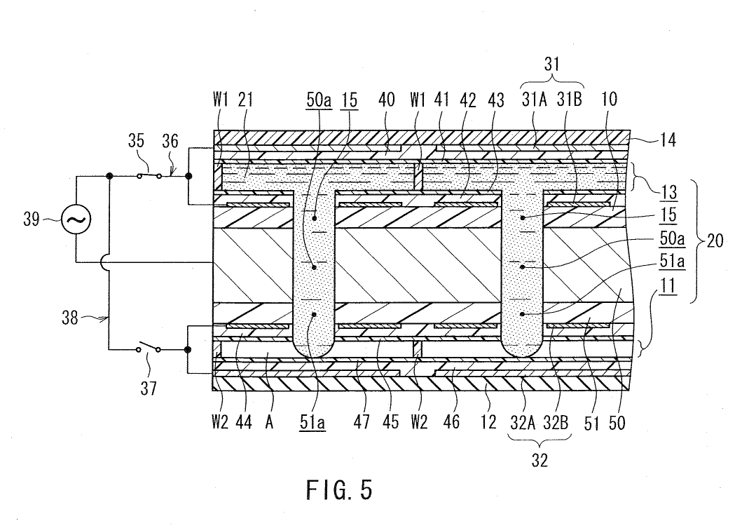

FIG. 5 is a sectional view showing a configuration of a main portion of a modified embodiment of the display device and the image display shown in FIG. 4A in the state of displaying a color resulting from the conductive liquid. In this figure, a main difference between the present modified embodiment and the Embodiment 2 described above lies in the use of the air instead of the nonpolar oil. Incidentally, elements provided in common with the Embodiment 2 described above are given the same reference numerals, and the redundant description thereof will be omitted here.

In FIG. 5, in the present modified embodiment, a transparent air A is sealed so as to be movable in the liquid storage portion 20. This air A has a physical property of not mixing with the conductive liquid 21 and moves inside the liquid storage portion 20 according to the movement of the conductive liquid 21 similarly to the nonpolar oil 22 described above. More specifically, when the conductive liquid 21 is moved toward the lower space 11, the air A moves from the inside of the lower space 11 toward the upper space 13 as shown in FIG. 5. As a result, similarly to the Embodiment 2, the state of displaying the color shown in FIG. 5 changes to the state of displaying white resulting from the reflecting sheet 10.

With the configuration described above, the present modified embodiment can produce effects similar to those in the Embodiment 2 described above.

### Embodiment 3

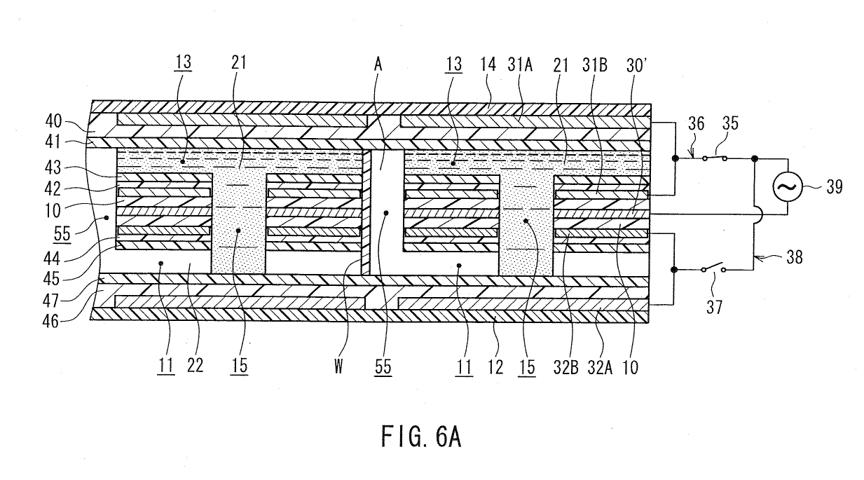

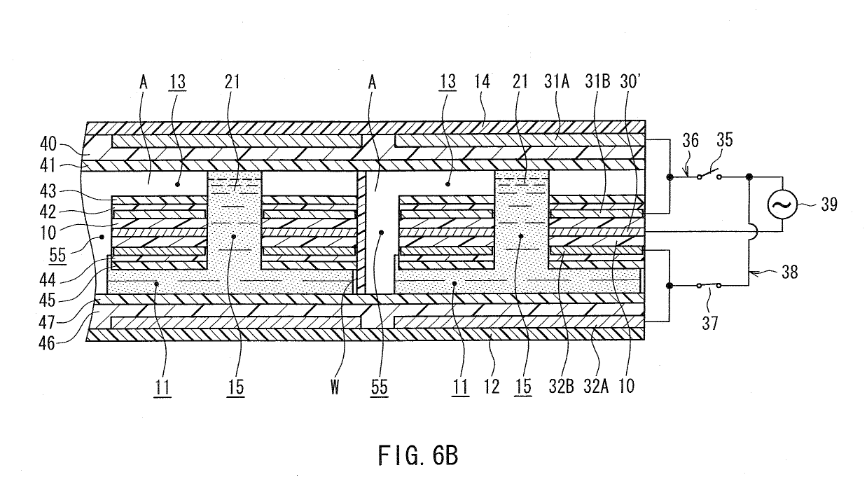

FIG. 6A is a sectional view showing a configuration of a main portion of a display device and an image display according to Embodiment 3 of the present invention in a state of displaying a color resulting from a conductive liquid. FIG. 6B is a sectional view showing the configuration of the main portion of the display device and the image display shown in FIG. 6A in a state of displaying white. In these figures, a main difference between the present embodiment and the Embodiment 1 described above lies in the formation of two through holes included in a communication space in one pixel region. Incidentally, elements provided in common with the Embodiment 1 described above are given the same reference numerals, and the redundant description thereof will be omitted here.

As shown in FIGS. 6A and 6B, in the present embodiment, a through hole 55 serving as a communication space allowing the upper space 13 and the lower space 11 to communicate with each other on the left side of the figure is provided in each pixel region. More specifically, in the present embodiment, in addition to the through hole 15 formed in the central portion of the pixel region, the through hole 55 whose upper end opening and lower end opening are formed respectively in the upper space 13 and the lower space 11 is provided on one end (left end) of this pixel region. Also, in the present embodiment, two adjacent pixel regions are divided by a partition wall W, and the through holes 15 and 55, the upper space 13 and the lower space 11 form a liquid storage portion in each pixel. Then, in the present embodiment, the conductive liquid 21 flows toward the upper space 13 or the lower space 11 via the inside of the through hole 15 and the nonpolar oil 22 flows toward the lower space 11 or the upper space 13 via the inside of the through hole 55 according to this inflow (movement) of the conductive liquid 21, thereby performing an operation of changing a display color on the display surface side.

With the configuration described above, the present embodiment can produce effects similar to those in the Embodiment 1 described above. Also, in the present embodiment, the conductive liquid 21 and the nonpolar oil 22 respectively flow into one side and the other side of the upper space 13 and the lower space 11 via the inside of the through holes 15 and 55, thereby performing the operation of changing the display color on the display surface side, making it easier to achieve a faster changing operation.

Moreover, alternatively to the above description, instead of the through holes 15 and 55, it also may be possible to use communication spaces that have, for example, a rectangular cross-section and a rectangular-parallelepiped shape. Also, instead of the through holes 15 and 55, it also may be possible to provide a through hole allowing the upper space 13 and the lower space 11 to communicate with each other on the right side of the figure, or omit the through hole 15 in the central portion so that the two through holes on the right and left sides and the upper and lower spaces form a liquid storage portion with a frame-shaped cross-section. In other words, a plurality of the through holes, each of which has a communication point with the upper space 13 and a communication point with the lower space 11 that are different from each other, may be formed on the reflecting sheet 10 serving as an intermediate layer. In this case, it is possible to circulate the conductive liquid 21 inside the upper space 13 and the lower space 11 when moving the conductive liquid 21, which is preferable because the speed of changing the display color on the display surface side can be raised easily. This also applies to embodiments described below.

### Embodiment 4

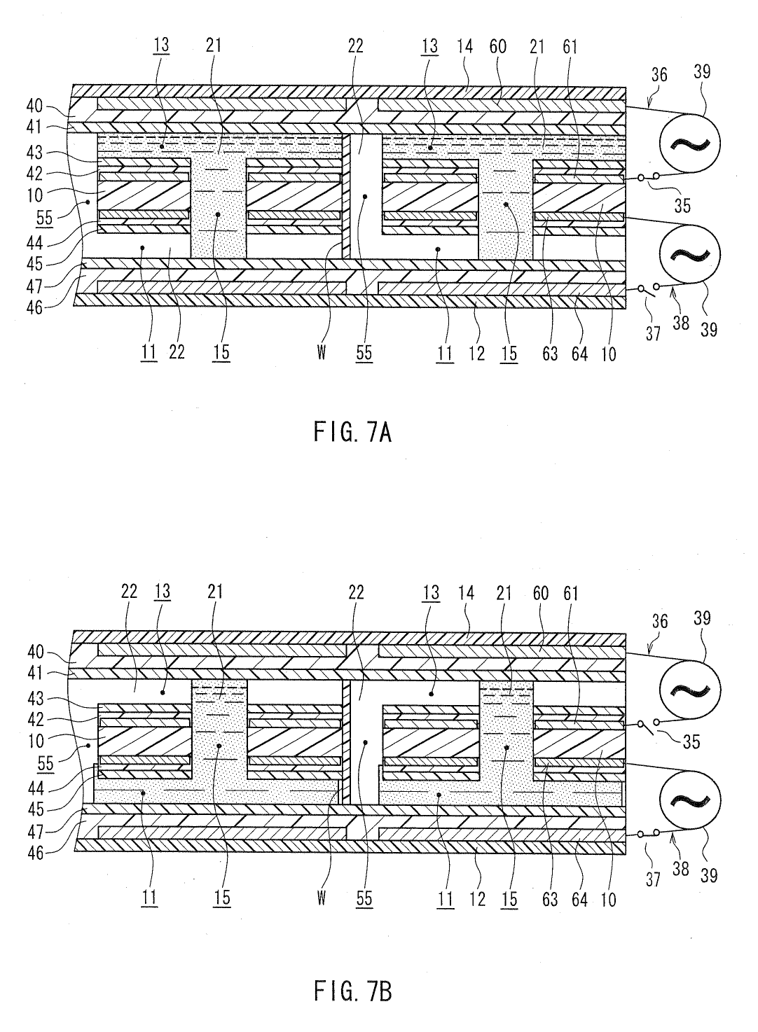

FIG. 7A is a sectional view showing a configuration of a main portion of a display device and an image display according to Embodiment 4 of the present invention in a state of displaying a color resulting from a conductive liquid. FIG. 7B is a sectional view showing the configuration of the main portion of the display device and the image display shown in FIG. 7A in a state of displaying white. In these figures, a main difference between the present embodiment and the Embodiment 3 described above lies in the provision of two alternating-current power supplies that are connected to the upper electrode and the lower electrode, respectively. Incidentally, elements provided in common with the Embodiment 3 described above are given the same reference numerals, and the redundant description thereof will be omitted here.

Further, in the present embodiment, two alternating-current power supplies 39 serving as a first power supply and a second power supply are provided, so that the conductive liquid 21 can be moved inside the liquid storage portion 20 described above without providing the common electrode. More specifically, an upper-side upper electrode 60 is provided on the lower surface of the upper electrode substrate 14 so as to cover the display surface side of the upper space 13. Also, on the side of the reflecting sheet 10, a lower-side upper electrode 61 is provided on the surface opposed to the upper space 13 except for the openings of the through holes 15 and 55. These upper electrodes 60 and 61 are made of a transparent electrode using an ITO film or the like. Moreover, the upper electrodes 60 and 61 are included in the first driving circuit 36, and connected to an upper-side alternating-current power supply 39 via the upper switch 35. Moreover, the dielectric layer 40 and the water-repellent film 41 are layered in this order on the surface of the upper electrode 60, and the dielectric layer 42 and the water-repellent film 43 are layered in this order on the surface of the upper electrode 61.

Further, a lower-side lower electrode 64 is provided on the upper surface of the lower electrode substrate 12 so as to cover the non-display surface side of the lower space 11. Also, on the side of the reflecting sheet 10, an upper-side lower electrode 63 is provided on the surface opposed to the lower space 11 except for the openings of the through holes 15 and 55. These lower electrodes 63 and 64 are electrodes made of a metal such as aluminum or copper. And, the lower electrodes 63 and 64 are included in the second driving circuit 38, and are connected to a lower-side alternating-current power supply 39 via the lower switch 37. Moreover, the dielectric layer 44 and the water-repellent film 45 are layered in this order on the surface of the lower electrode 63, and the dielectric layer 46 and the water-repellent film 47 are layered in this order on the surface of the lower electrode 64.

In the present embodiment constituted as above, when the upper switch 35 and the lower switch 37 are turned ON and OFF respectively, the conductive liquid 21 spreads out inside the upper space 13, so that the color resulting from the conductive liquid 21 is displayed on the display surface as shown in FIG. 7A.

On the other hand, when the upper switch 35 and the lower switch 37 are turned OFF and ON respectively, the conductive liquid 21 moves to the inside of the lower space 11 and the nonpolar oil 22 spreads out inside the upper space 13 as shown in FIG. 7B, so that white resulting from the reflecting sheet 10 is displayed on the display surface.

With the configuration described above, the present embodiment can produce effects similar to those in the Embodiment 3 described above. Also, in the present embodiment, since the two alternating-current power supplies (the power supply portion) 39 that are respectively connected to the first driving circuit 36 and the second driving circuit 38 are used, the first driving circuit 36 and the second driving circuit 38 can move the conductive liquid 21 independently of each other. Thereby, in the present embodiment, it is possible to raise the moving speed of the conductive liquid 21 more easily. Moreover, the first driving circuit 36 and the second driving circuit 38 can change the display color, by moving the conductive liquid 21 according to a voltage difference between a voltage applied by the upper-side alternating-current power supply (the first power source) 39 and the voltage applied by the lower-side alternating-current power supply (the second power source) 39, besides performing the ON/OFF control of each of the upper switch 35 and the lower switch 37. Moreover, in the present embodiment, it is possible to carry out a control of the movement of the conductive liquid 21 according to the voltage difference more easily, compared with the case of using one alternating-current power supply 39 commonly. This also applies to embodiments described below.

### Embodiment 5

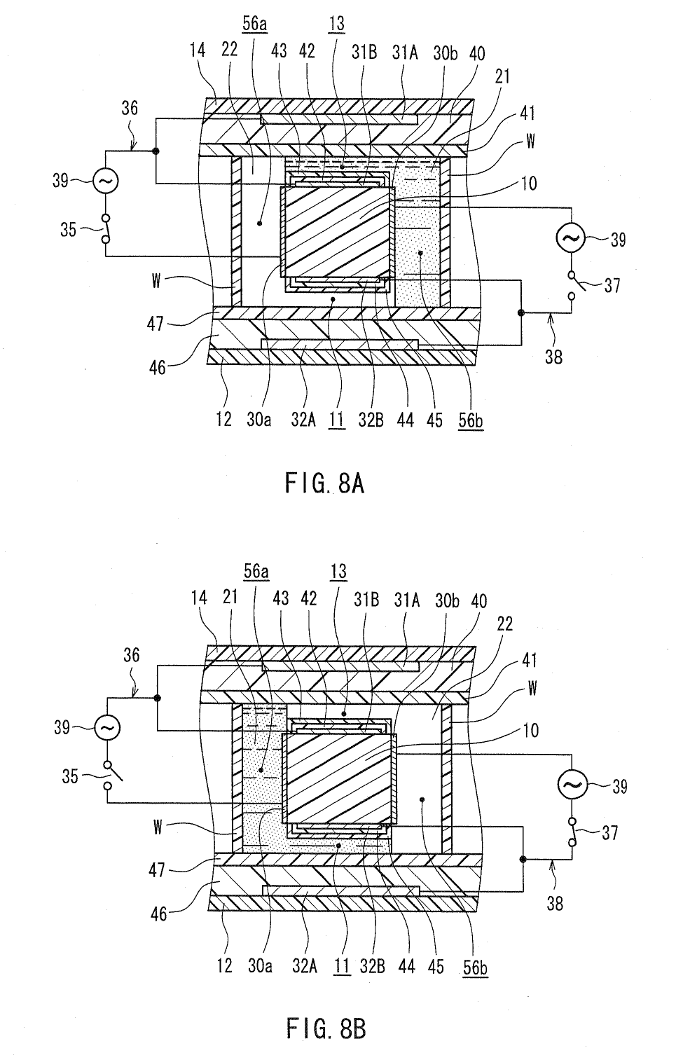

FIG. 8A is a sectional view showing a configuration of a main portion of a display device and an image display according to Embodiment 5 of the present invention in a state of displaying a color resulting from a conductive liquid. FIG. 8B is a sectional view showing the configuration of the main portion of the display device and the image display shown in FIG. 8A in a state of displaying white. In these figures, a main difference between the present embodiment and the Embodiment 1 described above lies in the provision of a first through hole that allows an one end portion side of the upper space and an one end portion side of the lower space to communicate with each other, and a second through hole that allows an other end portion side of the upper space and an other end portion side of the lower space to communicate with each other. Incidentally, elements provided in common with the Embodiment 1 described above are given the same reference numerals, and the redundant description thereof will be omitted here.

As shown in FIGS. 8A and 8B, in the present embodiment, a first through hole 56a is formed so that an upper end portion and an lower end portion thereof are in communication with sides of left end portions of the upper space 13 and the lower space 11, respectively. Moreover, a second through hole 56b is formed so that an upper end portion and an lower end portion thereof are in communication with sides of right end portions of the upper space 13 and the lower space 11, respectively. And, in the present embodiment, as shown in the figures, the liquid storage space 20 described above in each pixel is constituted so as to have a frame-shaped cross-section.

Moreover, in the present embodiment, similarly to the Embodiment 4 described above, the two alternating-current power supplies 39 that are respectively connected to the first driving circuit 36 and the second driving circuit 38 are used, so that the first driving circuit 36 and the second driving circuit 38 can move the conductive liquid 21 independently to each other.

With the configuration described above, the present embodiment can produce effects similar to those in the Embodiment 1 described above. Also, in the present embodiment, since the liquid storage space 20 is constituted so as to have a frame-shaped cross-section, the conductive liquid 21 can be circulated inside the liquid storage space 20 easily when being moved, making it possible to raise the speed of changing the display color on the display surface side easily.

### Embodiment 6

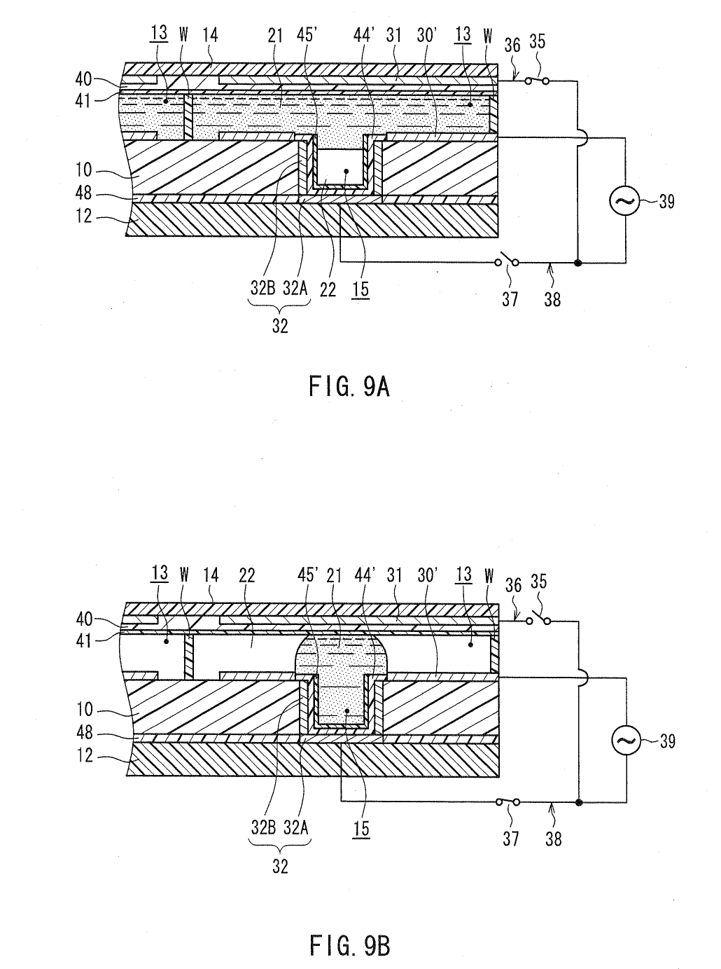

FIG. 9A is a sectional view showing a configuration of a main portion of a display device and an image display according to Embodiment 6 of the present invention in a state of displaying a color resulting from a conductive liquid. FIG. 9B is a sectional view showing the configuration of the main portion of the display device and the image display shown in FIG. 9A in a state of displaying white. In these figures, a main difference between the present embodiment and the Embodiment 1 described above lies in the omission of the above-noted lower space. Incidentally, elements provided in common with the Embodiment 1 described above are given the same reference numerals, and the redundant description thereof will be omitted here.

As shown in FIGS. 9A and 9B, in the present embodiment, the reflecting sheet 10 and the lower electrode substrate 12 are layered via an adhesive layer 48.

Further, in a central portion of each pixel region of the reflecting sheet 10, a through hole 15 penetrating through the reflecting sheet 10 in its thickness direction (the vertical direction in the figures) is provided. This through hole 15 constitutes a communication space, and one end thereof is in communication with the upper space 13. Also, the other end of the through hole 15 is closed airtightly by a lower electrode 32A, which will be described later. Then, in the present embodiment, the through hole 15 and the upper space 13 form the liquid storage portion 20 having a T-shaped cross-section in each pixel. Also, in this liquid storage portion 20, the conductive liquid 21 and the nonpolar oil 22 are sealed similarly to the Embodiment 1. In addition, the conductive liquids 21 that are colored in different colors are sealed in two adjacent liquid storage portions divided by the partition wall W, so that display colors on the display surface side can be corresponding colors of R, G and B.

Further, the lower electrode 32 is provided in the reflecting sheet 10 and the lower electrode substrate 12 so as to surround the through hole 15. More specifically, on an upper surface of the lower electrode substrate 12, the lower-side lower electrode 32A is provided so as to close a lower end opening of the through hole 15. Also, in the reflecting sheet 10, a cylindrical lower electrode 32B is provided on the surface opposed to the through hole 15. Then, these lower electrodes 32A and 32B are included in the second driving circuit 38, and are connected electrically with each other. Moreover, the lower electrodes 32A and 32B are connected to one end of the alternating-current power supply 39 via the lower switch 37. Moreover, similarly to the Embodiment 1, a dielectric layer 44′ and a water-repellent film 45′ are layered in this order on the surface of the lower electrode 32.

Further, a common electrode film 30′ serving as a common electrode is formed on the surface of the reflecting sheet 10 on the side of the upper space 13. This common electrode film 30′ is made of a transparent conductive film such as an ITO film and connected to the other end of the alternating-current power supply 39. Also, the upper electrode 31 is provided on the side of the upper electrode substrate 12 such that the upper space 13 is interposed between the upper electrode 31 and the common electrode film 30′. This upper electrode 31 is included in the first driving circuit 36, and is connected to the one end of the alternating-current power supply 39 via the upper switch 35.

In the present embodiment constituted as above, when the upper switch 35 and the lower switch 37 respectively are switched from the state shown in FIG. 9A to the OFF state and the ON state, the conductive liquid 21 moves from the inside of the upper space 13 toward the inside of the through hole 15 and the nonpolar oil 22 flows into the upper space 13 as shown in FIG. 9B. As a result, white resulting from the reflecting sheet 10 is displayed on the display surface.

On the other hand, when the upper switch 35 and the lower switch 37 respectively are switched from the state shown in FIG. 9B to the ON state and the OFF state, the conductive liquid 21 moves from the inside of the through hole 15 toward the inside of the upper space 13 and the nonpolar oil 22 returns to the inside of the through hole 15 as shown in FIG. 9A. As a result, the color resulting from the conductive liquid 21 is displayed on the display surface.

With the configuration described above, the present embodiment can produce effects similar to those in the Embodiment 1 described above. Also, in the present embodiment, since the reflecting sheet 10 and the lower electrode substrate 12 are joined directly via the adhesive layer 48 without providing the lower space therebetween unlike the Embodiment 1, the dimension of the display device in its thickness direction can be reduced easily, thereby achieving a compact display device more easily.

Alternatively to the above description, the upper electrode 31 may be buried into the upper electrode substrate 14 formed of an insulating material. In that case, it becomes possible to omit the dielectric layer on the upper electrode substrate 14. Moreover, the through hole 15 may be structured such that the other end side thereof is directly closed by the lower electrode substrate 12. This also applies to embodiments described below.

Further, instead of the through hole 15 described above, a recessed portion formed in the reflecting sheet 10 may be used. In other words, a communication space with a bottom also may be used. Moreover, instead of the through hole 15, it also may be possible to use a communication space that has, for example, a rectangular cross-section and a rectangular-parallelepiped shape or form a liquid storage space by two or more through holes. This also applies to embodiments described below.

Further, alternatively to the above description, instead of the cylindrical lower electrode 32B, a cylindrical common electrode can also be used similarly to the Embodiment 1. This also applies to embodiments described below.

### Embodiment 7

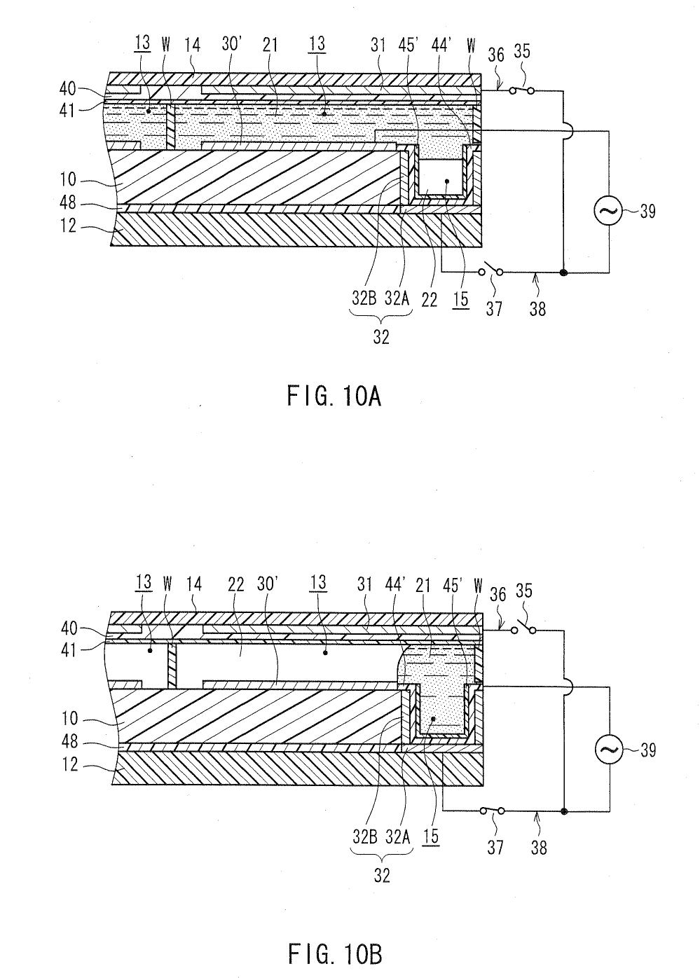

FIG. 10A is a sectional view showing a configuration of a main portion of a display device and an image display according to Embodiment 7 of the present invention in a state of displaying a color resulting from a conductive liquid. FIG. 10B is a sectional view showing the configuration of the main portion of the display device and the image display shown in FIG. 10A in a state of displaying white. In these figures, a main difference between the present embodiment and the Embodiment 6 described above lies in that the one end of the through hole is in communication with the one end portion of the upper space. Incidentally, elements provided in common with the Embodiment 6 described above are given the same reference numerals, and the redundant description thereof will be omitted here.

As shown in FIGS. 10A and 10B, in the present embodiment, in the reflecting sheet 10, the through hole 15 is provided on one end side of the reflecting sheet 10 in its transverse direction, for example, on a right end side of the figures, and allows to communicate with the right end portion of the upper space 13 in the figures so as to form the liquid storage portion 20 having a L-shaped cross-section.

With the configuration described above, in the present embodiment, the conductive liquid 21 can be moved toward the upper space 13 side or the through hole 15 side according to the operations of opening/closing the upper switch 35 and the lower switch 37 similarly to the Embodiment 6, and the present embodiment can produce effects similar to those in the Embodiment 6 described above. Also, in the present embodiment, since the through hole 15 is in communication with the one end portion of the upper space 13, the conductive liquid 21 flown from the through hole 15 side flows toward the left end portion side of the upper space 13 in one direction along the transverse direction in the figures, thus flowing into the upper space 13 side. Likewise, when flowing out of the upper space 13, the conductive liquid 21 flows from the upper space 13 side toward the inside of the through hole 15 in a reverse direction along the transverse direction in the figures, thus returning to the through hole 15 side. As a result, in the present embodiment, it is possible to move the conductive liquid 21 toward the upper space 13 side or the through hole 15 side smoothly.

### Embodiment 8

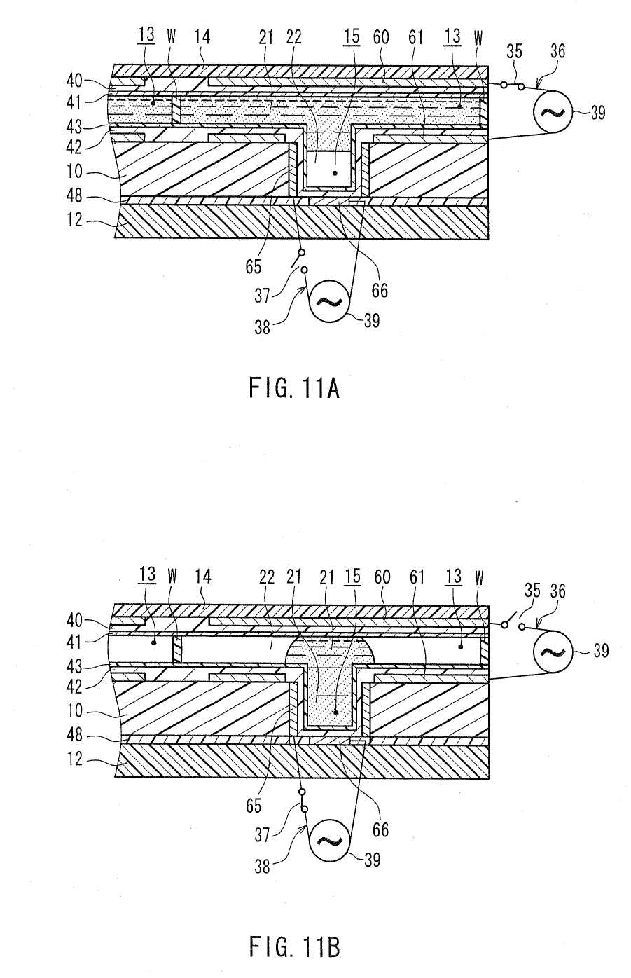

FIG. 11A is a sectional view showing a configuration of a main portion of a display device and an image display according to Embodiment 8 of the present invention in a state of displaying a color resulting from a conductive liquid. FIG. 11B is a sectional view showing the configuration of the main portion of the display device and the image display shown in FIG. 11A in a state of displaying white. In these figures, a main difference between the present embodiment and the Embodiment 6 described above lies in the provision of two alternating-current power supplies that are connected to the upper electrode and the lower electrode, respectively. Incidentally, elements provided in common with the Embodiment 6 described above are given the same reference numerals, and the redundant description thereof will be omitted here.

Further, in the present embodiment, similarly to the Embodiment 4, two alternating-current power supplies 39 as the first power supply and the second power supply are provided, so that the conductive liquid 21 can be moved inside the liquid storage portion 20 described above without providing the common electrode. More specifically, an upper-side upper electrode 60 is provided on the lower surface of the upper electrode substrate 14 so as to cover the display surface side of the upper space 13. Also, on the side of the reflecting sheet 10, a lower-side upper electrode 61 is provided on the surface opposed to the upper space 13 except for the opening of the through hole 15. These upper electrodes 60 and 61 are made of a transparent electrode using an ITO film or the like. Moreover, the upper electrodes 60 and 61 are included in the first driving circuit 36, and connected to the upper-side alternating-current power supply 39 via the upper switch 35. Moreover, the dielectric layer 40 and the water-repellent film 41 are layered in this order on the surface of the upper electrode 60, and the dielectric layer 42 and the water-repellent film 43 are layered in this order on the surface of the upper electrode 61.

On the other hand, on the upper surface of the lower electrode substrate 12, a lower-side lower electrode 66 is provided so as to close the lower end opening of the through hole 15. Also, a cylindrical lower electrode 65 is provided on the surface of the reflecting sheet 10 opposed to the through hole 15. Moreover, these lower electrodes 65 and 66 are included in the second driving circuit 38, and connected electrically to each other. Also, the lower electrodes 65 and 66 are connected to the lower-side alternating-current power supply 39 via the lower switch 37. Moreover, on the surfaces of the lower electrodes 65 and 66, the above-described dielectric layer 42 and the water-repellent film 43 are layered in this order.

With the configuration described above, the present embodiment can produce effects similar to those in the Embodiment 6 described above. Also, in the present embodiment, since the two alternating-current power supplies (the power supply portion) 39 that are respectively connected to the first driving circuit 36 and the second driving circuit 38 are used, the first driving circuit 36 and the second driving circuit 38 can move the conductive liquid 21 independently of each other. Thereby, in the present embodiment, it is possible to raise the moving speed of the conductive liquid 21 more easily.

### Embodiment 9

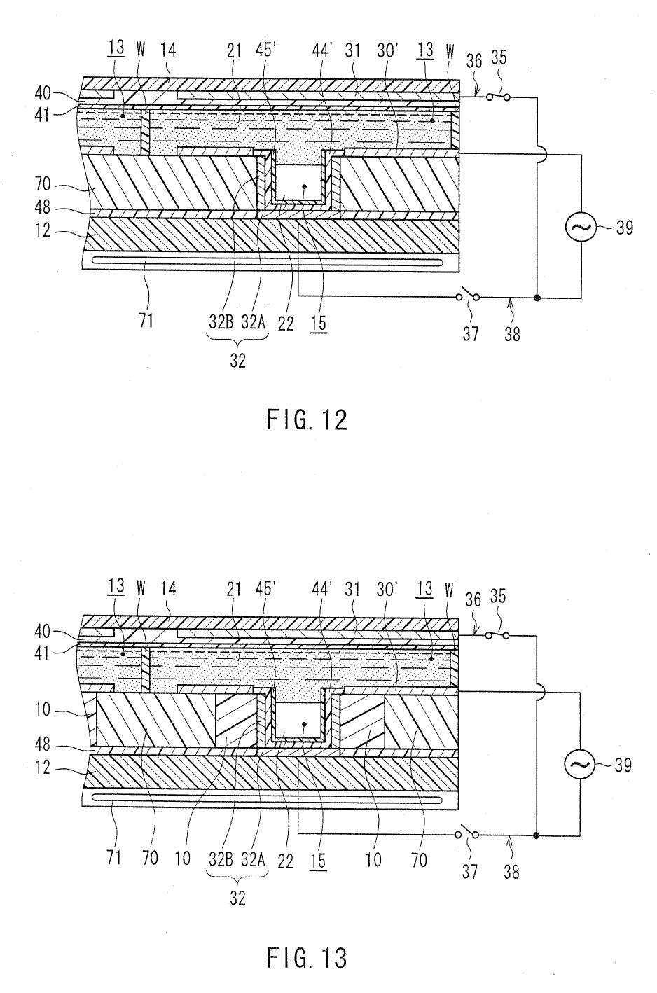

FIG. 12 is a sectional view showing a configuration of a main portion of a display device and an image display according to Embodiment 9 of the present invention in a state of displaying a color resulting from a conductive liquid. In these figures, a main difference between the present embodiment and the Embodiment 6 described above lies in the provision of a transparent sheet instead of the reflecting sheet and the provision of a back light on a lower side of the lower electrode substrate. Incidentally, elements provided in common with the Embodiment 6 described above are given the same reference numerals, and the redundant description thereof will be omitted here.

As shown in FIG. 12, in the present embodiment, a transparent sheet 70 is joined on the lower electrode substrate 12 via the adhesive layer 48. The transparent sheet 70 constitutes the intermediate layer, and is formed of a transparent PET resin similarly to the lower electrode substrate 12. Moreover, in the present embodiment, a back light 71 that emits white illumination light is provided on the lower side (a back side) of the lower electrode substrate 12, and can perform an operation of lighting as necessary regardless of the operations of opening/closing the upper switch 35 and the lower switch 37.

With the configuration described above, the present embodiment can produce effects similar to those in the Embodiment 6 described above. Also, in the present embodiment, since the display device of a transmission-type is constituted by providing the back light 71, the white display can be achieved by the illumination light from the back light 71, making it possible to carry out a suitable operation of display even when the external light is not sufficient or in the night time. Thereby, the display quality of the white display can be improved easily. Alternatively to the above description, by changing an emission color of the back light, it is possible to change the display color on the display surface side according to the emission color. Moreover, it is possible to change a brightness of the display device easily by using the back light 71, making it possible to easily structure the display device that has a wide dimming range and can perform a control of the gradation with high precision.

Incidentally, the above description has been directed to the case of using the transparent sheet 70 and the lower electrode substrate 12 that are joined via the adhesive layer 48, but the present embodiment is not limited to this, as long as it has a configuration where a light-transmitting layer is used as the back surface layer that is provided on the non-display surface side of the upper layer, and the back light is provided on the non-display surface side of the back surface layer.

### Embodiment 10

FIG. 13 is a sectional view showing a configuration of a main portion of a display device and an image display according to Embodiment 10 of the present invention in a state of displaying a color resulting from a conductive liquid. In these figures, a main difference between the present embodiment and the Embodiment 6 described above lies in the provision of a reflecting sheet and a transparent sheet in parallel and the provision of a back light on a lower side of the lower electrode substrate. Incidentally, elements provided in common with the Embodiment 6 described above are given the same reference numerals, and the redundant description thereof will be omitted here.

As shown in FIG. 13, in the present embodiment, the reflecting sheet 10 and the transparent sheet 70 are joined via the adhesive layer 48 on the lower electrode substrate 12. The reflecting sheet 10 and the transparent sheet 70 constitute the intermediate layer, and are provided in parallel in the transverse direction in the figure. More specifically, as shown in FIG. 13, the reflecting sheet 10 is disposed in the central portion of the pixel region, and the transparent sheet 70 formed of a transparent PET resin is disposed in a peripheral portion of the pixel region so as to sandwich the reflecting sheet 10 in the transverse direction described above. Moreover, in the present embodiment, the back light 71 that emits white illumination light is provided on the lower side (the back surface side) of the lower electrode substrate 12, and can carry out the operation of lighting as necessary, regardless of the operations of opening/closing the upper switch 35 and the lower switch 37.

With the configuration described above, the present embodiment can produce effects similar to those in the Embodiment 6 described above. Also, in the present embodiment, since the reflecting sheet 10, the transparent sheet 70 and the back light 71 are provided so as to constitute the semitransparent display device, the white display can be achieved by the reflected light of the external light resulting from the reflecting sheet 10 and the illumination light from the back light 71, making it possible to achieve a suitable operation of display. Thereby, the display quality of the white display can be improved easily. Moreover, since the external light can be used besides the back light 71, it is possible to reduce the power consumption of the back light 71. Alternatively to the above description, a configuration where the transparent sheet 70 and the reflecting sheet 10 are respectively disposed in the central portion and the peripheral portion of the pixel region may also be applied.

Incidentally, the above description has been directed to the case of using the lower electrode substrate 12, the reflecting sheet 10 and the transparent sheet 70 that are joined via the adhesive layer 48, but the present embodiment is not limited to this, as long as it has a configuration where a light-reflecting layer and a light-transmitting layer that are provided in parallel are used as the back surface layer that is provided on the non-display surface side of the upper layer, and the back light is provided on the non-display surface side of the back surface layer.

### Embodiment 11

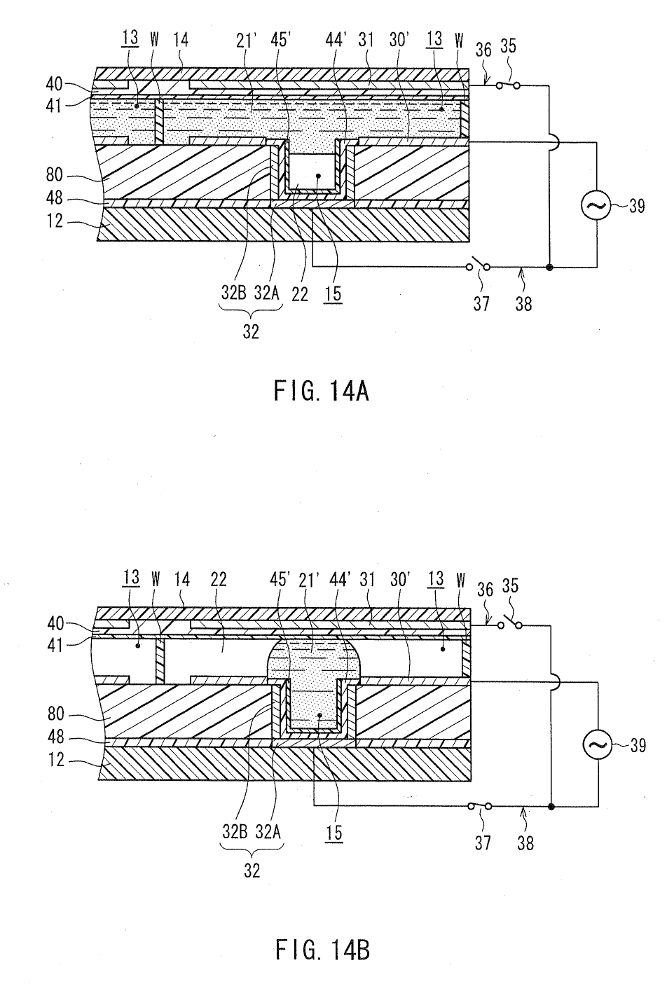

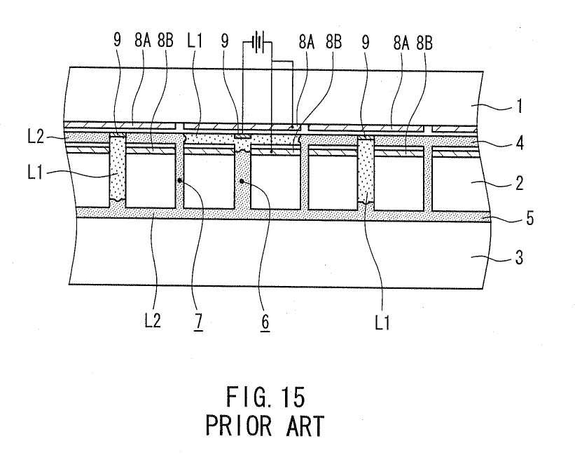

FIG. 14A is a sectional view showing a configuration of a main portion of a display device and an image display according to Embodiment 11 of the present invention in a state of displaying a color resulting from a conductive liquid. FIG. 14B is a sectional view showing the configuration of the main portion of the display device and the image display shown in FIG. 14A in a state of displaying white. In these figures, a main difference between the present embodiment and the Embodiment 6 described above lies in that light-scattering particles are mixed into the conductive liquid. Incidentally, elements provided in common with the Embodiment 6 described above are given the same reference numerals, and the redundant description thereof will be omitted here.

As shown in FIGS. 14A and 14B, a conductive liquid 21′ of the present embodiment is not a colored liquid that is colored in a predetermined color but is a light-scattering liquid. More specifically, no pigment or the like is added into the conductive liquid 21′, but light-scattering particles such as titanium oxide particles and hollow particles are mixed therein, so that the conductive liquid 21′ is made the light-scattering liquid that scatters and reflects the external light.

Moreover, in the present embodiment, a colored sheet 80 is joined on the lower electrode substrate 12 via the adhesive layer 48. The colored sheet 80 constitutes the intermediate layer, and a surface of the colored sheet 80 on the display surface side is colored in a predetermined color, that is, a color of any of R, G and B.

In the present embodiment with the above configuration, when the conductive liquid 21′ is moved toward the upper space 13 side as shown in FIG. 14A, the display color on the display surface side is becomes white resulting from the light-scattering particles. On the other hand, when the conductive liquid 21′ is moved toward the lower space 11 side as shown in FIG. 14B, the display color on the display surface side becomes the predetermined color resulting from the colored sheet 80.

With the configuration described above, the present embodiment can produce effects similar to those in the Embodiment 6 described above.

Incidentally, the above description has been directed to the case of using the colored sheet 80 and the lower electrode substrate 12 that are joined via the adhesive layer 48, but the present embodiment is not limited to this, as long as it has a configuration where the surface of the back surface layer on the display surface side is colored in the predetermined color. Also, instead of the transparent common electrode film 30′, a common electrode film whose surface on the display surface side is colored in the predetermined color can be used.

It should be noted that the above-described embodiments are all illustrative and not limiting. The technical scope of the present invention is defined by the claims, and all changes within the range equivalent to the configurations recited therein also are included in the technical scope of the present invention.

For example, although the above description has been directed to the case of applying the present invention to an image display including a display portion that can display a color image, the present invention can be used in any electric apparatuses provided with a display portion for displaying information containing a character and an image without any particular limitation. The present invention can be used in a preferred manner in various electric apparatuses including a display portion, for example, personal digital assistants (PDAs) such as electronic personal organizers, displays attached to personal computers and TV sets, and electronic papers.

Moreover, the above description has been directed to the case of using the conductive liquid colored in the predetermined color or the conductive liquid with the light-scattering particles mixed therein, but the present invention is not limited to them at all, as far as it has a configuration where the first driving circuit that allows the conductive liquid to flow into the inside of the display space according to the voltage applied by the power source portion and the second driving circuit that allows the conductive liquid to flow out of the inside of the display space according to the voltage applied by the power source portion are provided, and the display color on the display surface side can be changed by moving the conductive liquid with respect to the inside of the display space according to the application of the electric field to the conductive liquid. More specifically, a configuration using, for example, a transparent conductive liquid, a nonpolar oil colored in the predetermined color and the light-reflecting layer may be applied.

Moreover, the above description has been directed to the case of using the ionic liquid as the conductive liquid, but the conductive liquid of the present invention is not limited to this, and for example, alcohol, acetone, formaldehyde, ethyleneglycol, water or a mixture thereof may also be used as the conductive liquid.

Further, the above description has been directed to the case of using the nonpolar oil or the air, but the present invention is not limited to this, and any insulating fluid that is not mixed with the conductive liquid may be used.

However, in the case of using the nonpolar oil that is not compatible with the ionic liquid (the conductive liquid) as the above-described embodiment, a liquid drop of the ionic liquid can be moved in the nonpolar oil more easily, the ionic liquid can be moved at a higher speed, and the display color can be changed at a higher speed, compared with the case of using the air and the ionic liquid, thus being preferable.

Also, although the above description has been directed to the case of constituting the display surface including display spaces for individual colors of R, G and B, the present invention is not limited to this as long as a plurality of display spaces are provided respectively for a plurality of colors allowing a full color display on the display surface side. More specifically, display spaces in which colored liquids colored respectively in cyan (C), magenta (M) and yellow (Y) are sealed are provided instead of the display spaces for R, G and B described above, thus constituting the display spaces for individual colors of C, M and Y. However, in the case of constituting the display spaces for C, M and Y, it is more preferable to provide a display space for black having a colored liquid colored in black because the display quality of black display may deteriorate compared with the case of R, G and B. Furthermore, it also is possible to use colored liquids colored in predetermined colors corresponding to combinations of a plurality of colors that can display a color image on the display surface other than R, G, B and C, M, Y, for example, R, G, B, Y, C (five colors), R, G, B, C (four colors), R, G, B, Y (four colors), G, M (two colors), etc.

In addition, although the above description has been directed to the case of using the alternating-current power supply, the alternating-current power supply can be replaced with a direct-current power supply.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A display device having a plurality of pixel regions, the display device comprising:
a display space provided on a display surface side; and
a conductive liquid sealed inside the display space so as to be operable,
the display device being constituted so as to be able to change a display color on the display surface side according to an application of an electric field to the conductive liquid, wherein
a power source portion,
a first driving circuit that is connected to the power source portion, and allows the conductive liquid to flow into an inside of the display space according to a voltage applied by the power source portion, and
a second driving circuit that is connected to the power source portion, and allows the conductive liquid to flow out of the inside of the display space according to a voltage applied by the power source portion, are provided,
the display device further comprising:
a transparent upper layer provided on the display surface side; and
a back surface layer provided on a non-display surface side of the upper layer, wherein
the display space is formed between the upper layer and the back surface layer,
a communication space whose one end side is in communication with the display space is provided in the back surface layer so that the conductive liquid can flow,
the first driving circuit is provided with a transparent upper electrode provided on the upper layer side and an upper switch connected between the upper electrode and the power source portion, and allows the conductive liquid to flow from the communication space side to the display space side when the upper switch becomes in an ON, and
the second driving circuit is provided with a lower electrode provided on the back surface layer side and a lower switch connected between the lower electrode and the power source portion, and allows the conductive liquid to flow out from the display space side to the communication space side when the lower switch becomes in an ON, wherein
the back surface layer comprises:
an intermediate layer provided on the non-display surface side of the upper layer so that an upper space constituting the display space is formed between the upper layer and the intermediate layer; and the lower layer provided on a non-display surface side of the intermediate layer,
a lower space included in the communication space is formed between the intermediate layer and the lower layer,
a through hole, which is included in the communication space and whose one end side and other end side are respectively in communication with the upper space and the lower space, is formed in the intermediate layer, and
a common electrode provided in the intermediate layer is connected to the first driving circuit and the second driving circuit so as to be able to contact with the conductive liquid and surround the through hole, wherein
a plurality of the through holes are provided in the same pixel region of said plurality of pixel regions, each of which has a communication point with the upper space and a communication point with the lower space that are different from each other, are formed in the intermediate layer.

2. The display device according to claim 1, wherein
a dielectric layer is layered on a surface of the upper electrode and a surface of the lower electrode.

3. The display device according to claim 1, wherein
a first power source and a second power source that are respectively connected to the first driving circuit and the second driving circuit are used in the power source portion.

4. The display device according to claim 1, wherein
an insulating fluid that is not mixed with the conductive liquid is sealed inside the display space.

5. The display device according to claim 1, wherein
a plurality of the display spaces are respectively provided according to a plurality of colors, by which a full-color display can be carried out on the display surface side.

6. An electric apparatus comprising a display portion having a plurality of pixel regions for displaying information including a character and an image, wherein
a display device, which is provided with: a display space provided on a display surface side; and a conductive liquid sealed inside the display space so as to be operable, and is constituted so as to be able to change a display color on the display surface side according to an application of an electric field to the conductive liquid, is used as the display portion, and
a power source portion;
a first driving circuit that is connected to the power source portion, and allows the conductive liquid to flow into an inside of the display space according to a voltage applied by the power source portion; and
a second driving circuit that is connected to the power source portion, and allows the conductive liquid to flow out of the inside of the display space according to a voltage applied by the power source portion, are provided,
the display device further comprising:
a transparent upper layer provided on the display surface side; and
a back surface layer provided on a non-display surface side of the upper layer, wherein
the display space is formed between the upper layer and the back surface layer,
a communication space whose one end side is in communication with the display space is provided in the back surface layer so that the conductive liquid can flow,
the first driving circuit is provided with a transparent upper electrode provided on the upper layer side and an upper switch connected between the upper electrode and the power source portion, and allows the conductive liquid to flow from the communication space side to the display space side when the upper switch becomes in an ON, and
the second driving circuit is provided with a lower electrode provided on the back surface layer side and a lower switch connected between the lower electrode and the power source portion, and allows the conductive liquid to flow out from the display space side to the communication space side when the lower switch becomes in an ON, wherein
the back surface layer comprises:
an intermediate layer provided on the non-display surface side of the upper layer so that an upper space constituting the display space is formed between the upper layer and the intermediate layer; and the lower layer provided on a non-display surface side of the intermediate layer,
a lower space included in the communication space is formed between the intermediate layer and the lower layer,
a through hole, which is included in the communication space and whose one end side and other end side are respectively in communication with the upper space and the lower space, is formed in the intermediate layer, and
a common electrode provided in the intermediate layer is connected to the first driving circuit and the second driving circuit so as to be able to contact with the conductive liquid and surround the through hole, wherein
a plurality of the through holes are provided in the same pixel region of said plurality of pixel regions, each of which has a communication point with the upper space and a communication point with the lower space that are different from each other, are formed in the intermediate layer.
